(19) United States
(12) Patent Application Publication
(10) Pub. No.: US 2026/0156378 A1
(43) Pub. Date: Jun. 4, 2026

(54) IMAGE SENSOR AND OPERATION METHOD THEREOF

(71) Applicant: Samsung Electronics Co., Ltd., Suwon-si (KR)

(72) Inventor: Hyoun-Jee Ha, Suwon-si (KR)

(73) Assignee: Samsung Electronics Co., Ltd., Suwon-si (KR)

(21) Appl. No.: 19/389,990

(22) Filed: Nov. 14, 2025

(30) Foreign Application Priority Data
Dec. 4, 2024 (KR) 10-2024-0178854

(51) Int. Cl. H04N 25/50; H04N 25/11; H04N 25/78

(52) U.S. Cl. CPC H04N 25/50; H04N 25/11; H04N 25/78

(57) ABSTRACT

An image sensor includes a first photodiode disposed under a first micro lens and generates a first charge, a second photodiode disposed under the first micro lens and generates a second charge. A first output circuit transfers the first charge to a first floating diffusion region, amplifies the first charge, and outputs the amplified first charge as a first output voltage. Based on a first mode signal, a second output circuit transfers a second charge to a second floating diffusion region, amplifies the second charge, and outputs the amplified second charge as a second output voltage. Based on a second mode signal, the second output circuit amplifies the second charge, stores the amplified second charge as a first amplified charge in a storage region, amplifies the first amplified charge stored in the storage region, and outputs the amplified first amplified charge as the second output voltage.

### CROSS-REFERENCE TO RELATED APPLICATION

This application claims priority under 35 U.S.C. § 119 to Korean Patent Application No. 10-2024-0178854 filed on Dec. 4, 2024, in the Korean Intellectual Property Office, the disclosure of which is incorporated by reference herein in its entirety.

### BACKGROUND

Embodiments of the present disclosure described herein relate to an image sensor, and more particularly, relate to an image sensor and an operation method of the image sensor.

An image sensor converts light received through a photodiode into an electrical signal. Compared to other image sensors, a complementary metal oxide semiconductor (CMOS) image sensor may provide the following advantages: a convenient driving method, low power consumption, and the integration of signal processing circuits on a single chip.

The need for an image sensor having improved performance such as improvement of the quality of image and reduction of distortion is increasing.

### SUMMARY

Embodiments of the present disclosure provide an image sensor and an operation method of the image sensor.

According to an embodiment, an image sensor includes a first photodiode disposed under a first micro lens and generates a first charge; a second photodiode disposed under the first micro lens and generates a second charge; a first output circuit that transfers the first charge to a first floating diffusion region, amplifies the first charge, and outputs the amplified first charge as a first output voltage; and a second output circuit. Based on a first mode signal, the second output circuit transfers a second charge to a second floating diffusion region, amplifies the second charge, and outputs the amplified second charge as a second output voltage. Based on a second mode signal, the second output circuit amplifies the second charge to generate a first amplified charge, stores the first amplified charge in a storage region, amplifies the first amplified charge stored in the storage region, and outputs the amplified first amplified charge as the second output voltage.

According to an embodiment, an image sensor includes a first photodiode, a second photo diode, a first output circuit connected to the first photodiode and operates in a rolling shutter manner, and a second output circuit connected to the second photodiode and operates in the rolling shutter manner based on a first mode signal and operates in a global shutter manner based on a second mode signal. The first photodiode and the second photodiode are disposed under a first micro lens.

According to an embodiment, an operation method of an image sensor which includes a first photodiode, a second photodiode, a first output circuit, and a second output circuit, the first photodiode and the second photodiode disposed under a first micro lens, includes generating, by the first photodiode, a first charge; generating, by the second photodiode, a second charge; by the first output circuit: transferring the first charge to a first floating diffusion region, amplifying the first charge, and outputting the amplified first charge as a first output voltage; in response to receiving a first mode signal, by the second output circuit: transferring a second charge to a second floating diffusion region, amplifying the second charge, and outputting the amplified second charge as a second output voltage; and in response to receiving a second mode signal, by the second output circuit: amplifying the second charge, storing the amplified second charge as a first amplified charge in a storage region, amplifying the first amplified charge stored in the storage region, and outputting the amplified first amplified charge as the second output voltage.

### BRIEF DESCRIPTION OF THE FIGURES

The above and other objects and features of embodiments described in the present disclosure will become apparent by describing in detail embodiments thereof with reference to the accompanying drawings.

FIG. 1 is a diagram illustrating an image sensor according to some embodiments.

FIG. 2 is a diagram describing an image sensor according to some embodiments.

FIG. 3 is a circuit diagram of a rolling pixel unit of FIG. 1 according to some embodiments.

FIG. 4 is a circuit diagram of a hybrid pixel unit of FIG. 1 according to some embodiments.

FIG. 5 is a diagram describing a rolling shutter manner according to some embodiments.

FIG. 6 is a diagram describing a global shutter manner according to some embodiments.

FIG. 7 is a diagram illustrating a pixel array according to some embodiments.

FIG. 8 is a circuit diagram of a first pixel group of FIG. 7, according to some embodiments.

FIG. 9 is a block diagram illustrating an ADC circuit and an image signal processor of FIG. 1 in detail according to some embodiments.

FIG. 10 is a circuit diagram illustrating pre-charge circuits of a first pixel group of FIG. 8 in detail according to some embodiments.

FIG. 11 is a diagram describing an operation of a first pixel group of FIG. 7 according to some embodiments.

FIG. 12 is a diagram describing a method in which an image signal processor of FIG. 1 operates based on a first mode signal, according to some embodiments.

FIG. 13 is a diagram describing an operation of a first pixel group of FIG. 7 according to some embodiments.

FIG. 14 is a diagram describing a method in which an image signal processor of FIG. 1 operates based on a second mode signal, according to some embodiments.

FIG. 15 is a diagram describing an operation of a first pixel group of FIG. 7 according to some embodiments.

FIG. 16 is a diagram describing a method in which an image signal processor of FIG. 1 operates based on a second mode signal, according to some embodiments.

FIG. 17 is a diagram illustrating a pixel array according to some embodiments.

FIG. 18 is a circuit diagram of a first pixel group of FIG. 17, according to some embodiments.

FIG. 19 is a diagram describing an operation of a first pixel group of FIG. 18 according to some embodiments.

FIG. 20 is a diagram describing a method in which an image signal processor of FIG. 1 operates based on a first mode signal, according to some embodiments.

FIG. 21 is a diagram describing a method in which an image signal processor of FIG. 1 operates based on a second mode signal, according to some embodiments.

FIG. 22 is a diagram illustrating a pixel array according to some embodiments.

FIG. 23 is a diagram of a first pixel group of FIG. 6, according to some embodiments.

FIG. 24 is a flowchart describing a method in which an image sensor operates, according to some embodiments.

FIG. 25 is a block diagram of an electronic device including a multi-camera module according to some embodiments.

FIG. 26 is a block diagram illustrating a camera module of FIG. 25 in detail according to some embodiments.

### DETAILED DESCRIPTION

Components which are described by referring to the terms used in the detailed description or the accompanying claims and function blocks illustrated in the accompanying drawings may be implemented in the form of software or hardware or in the form of a combination thereof. For example, the software may include a machine code, firmware, an embedded code, and application software. For example, the hardware may include an electrical circuit, an electronic circuit, a processor, a computer, integrated circuit cores, a passive element, or a combination thereof.

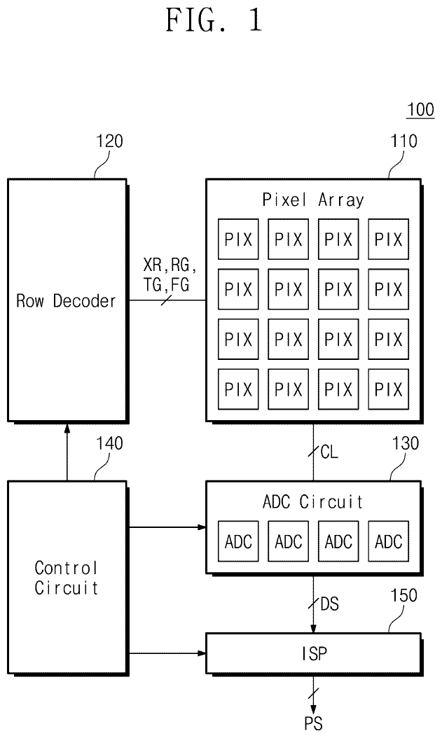

FIG. 1 is a block diagram illustrating an image sensor 100 according to some embodiments. Referring to FIG. 1, the image sensor 100 may include a pixel array 110, a row decoder 120, an analog-to-digital converter (ADC) circuit 130, a control circuit 140, and an image signal processor 150.

The pixel array 110 may include a plurality of pixel units PIX and may be in the form of a matrix including a plurality of pixel rows and a plurality of pixel columns. In other words, the plurality of pixel units PIX may be arranged in a row direction and a column direction. Each of the plurality of pixel units PIX of the pixel array 110 may output a pixel signal depending on the intensity or the amount of light incident from the outside (hereinafter, the pixel signal is referred to as an “output voltage”). In this case, the pixel signal may be an analog signal corresponding to the intensity or the amount of light incident from the outside. The pixel array 110 which includes 16 pixel units PIX disposed at intersections of four rows and four columns is illustrated in FIG. 1, but the present disclosure is not limited thereto. For example, the number of pixel units PIX may increase or decrease, and a structure in which the pixel units PIX are arranged may be implemented to be different from the above structure.

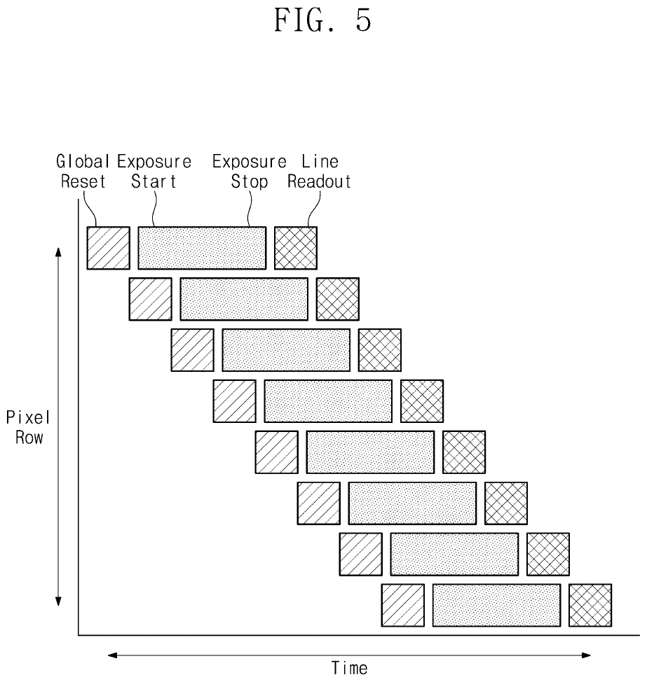

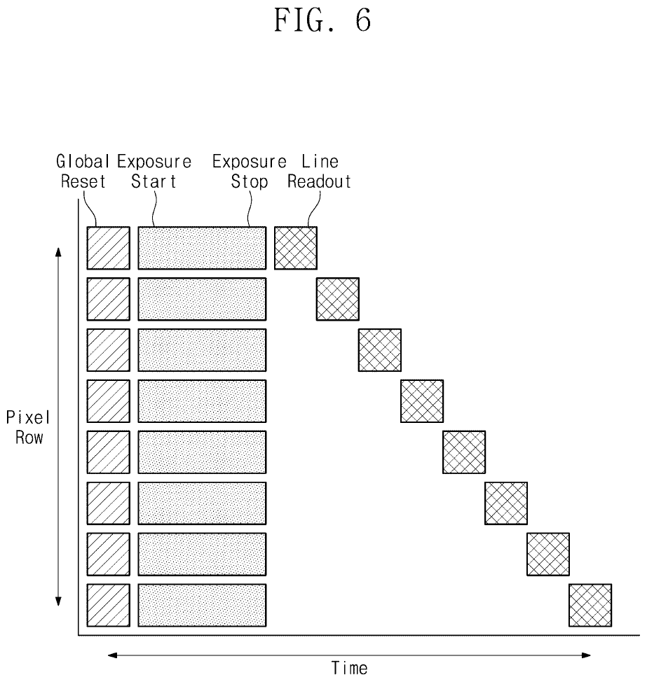

In some embodiments, some pixel units among the pixel units PIX may operate in a hybrid shutter manner. In this case, the pixel unit may be referred to as a “hybrid pixel unit.” The hybrid pixel unit may operate in one manner among a rolling shutter manner and a global shutter manner depending on a control signal such as a mode signal. The remaining pixel units among the pixel units PIX other than the hybrid pixel units may operate only in the rolling shutter manner. In this case, a pixel unit operating only in the rolling shutter manner may be referred to as a “rolling pixel unit.” The rolling shutter manner and the global shutter manner will be described in detail with reference to FIGS. 5 and 6.

For example, when high-resolution photography using the image sensor 100 is required, the hybrid pixel units may operate in the rolling shutter manner, and when video photography with low distortion is required, the hybrid pixel units may operate in the global shutter manner.

The row decoder 120 may provide the pixel array 110 with pixel driving signals such as a row selection signal XR, a reset signal RG, a transfer signal TG, and a floating control signal FG. The row decoder 120 may select one of the rows of the pixel array 110 under control of the control circuit 140. The row decoder 120 may generate the row selection signal XR to select one of the plurality of rows. The row decoder 120 may activate the reset signal RG, the transfer signal TG, and the floating control signal FG of the pixel unit PIX corresponding to the selected row, based on a given order.

The row decoder 120 may provide one of a first mode signal and a second mode signal to the pixel array 110 under control of the control circuit 140. For example, the row decoder 120 may receive one of the first mode signal and the second mode signal from the control circuit 140. The first mode signal or the second mode signal may include a signal for turning on or turning off some transistors in the hybrid pixel unit.

For example, the hybrid pixel unit may operate in the rolling shutter manner based on the first mode signal. The hybrid pixel unit may operate in the global shutter manner based on the second mode signal.

Afterwards, output voltages such as a reset voltage and a pixel voltage generated from the pixel unit PIX of the selected row may be provided to the ADC circuit 130.

The ADC circuit 130 may convert and output the reset voltage and the pixel voltage into a digital signal DS. For example, the ADC circuit 130 may sample the reset voltage and the pixel voltage in a correlated double sampling (CDS) manner and may convert the sampled result into the digital signal DS. To this end, the ADC circuit 130 may further include a correlated double sampler (not illustrated). The ADC circuit 130 may further include an output buffer circuit (not illustrated) which latches and outputs the digital signal DS. The output buffer circuit may temporarily store the converted digital signal DS and may then output the digital signal DS under control of the control circuit 140.

The control circuit 140 may control the pixel array 110, the row decoder 120, the ADC circuit 130, and the image signal processor 150. The control circuit 140 may include a timing controller (not illustrated). The timing controller may provide control signals, which are necessary for operations of the pixel array 110, the row decoder 120, and the ADC circuit 130, etc., such as a clock signal and a timing control signal. The control circuit 140 may include a logic control circuit, a phase locked loop circuit, a timing control circuit, a communication interface circuit, etc.

In some embodiments, the control circuit 140 may determine whether to provide the first mode signal to the row decoder 120 and the image signal processor 150 or whether to provide the second mode signal to the row decoder 120 and the image signal processor 150. For example, the control circuit 140 may determine whether to generate the first mode signal or whether to generate the second mode signal, depending on the control signal received from a user interface circuit.

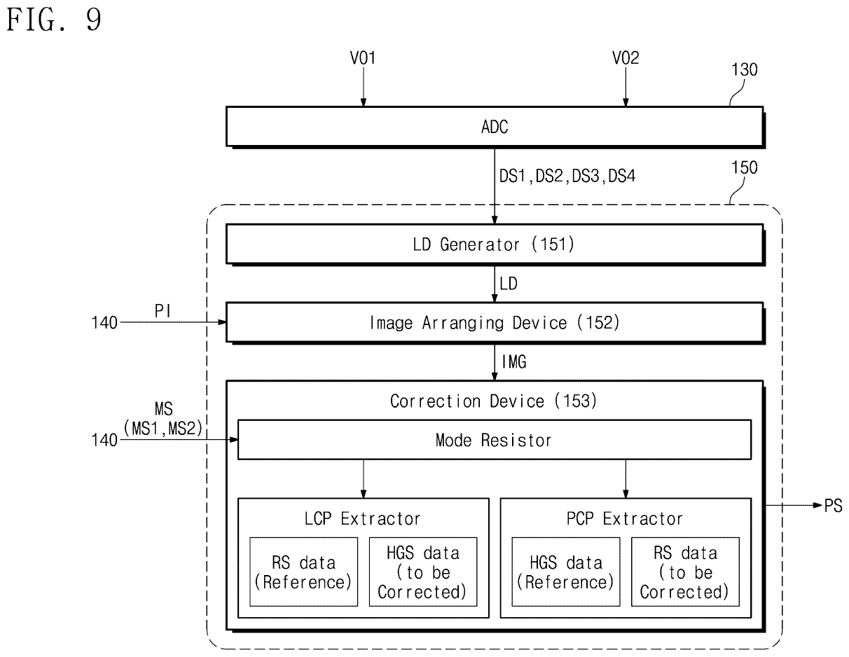

The image signal processor 150 may receive the digital signal DS from the ADC circuit 130. The image signal processor 150 may receive the same mode signals as provided to the row decoder 120 from the control circuit 140 and may receive position information. The position information may refer to information indicating a position of a pixel unit of the pixel array, which corresponds to the digital signal DS processed by the image signal processor 150. This will be described in detail with reference to FIG. 9. The image signal processor 150 may apply a given signal processing algorithm to the digital signal DS to generate a processed signal PS.

For example, the signal processing algorithm may include a denoising algorithm, a white balancing algorithm, etc.

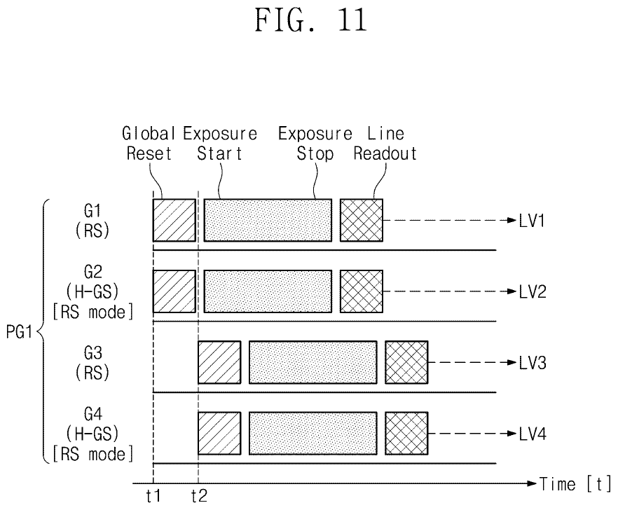

In some embodiments, the image sensor 100 may generate image data with an improved quality of image, by correcting hybrid shutter data corresponding to the hybrid pixel units based on rolling shutter data corresponding to the rolling pixel units, when the hybrid pixel units operate based on the first mode signal (i.e., when the hybrid pixel units operate in the rolling shutter manner). The hybrid shutter data may include information about luminance values respectively corresponding to the hybrid pixel units and positions in image data, at which the luminance values are respectively disposed. The rolling shutter data may include information about luminance values respectively corresponding to the rolling pixel units and positions in image data, at which the luminance values are respectively disposed. This will be described in detail with reference to FIGS. 11, 12, and 20.

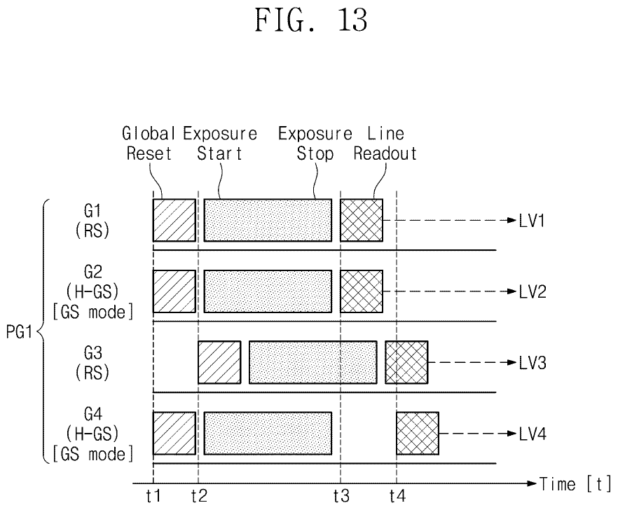

Alternatively, the image sensor 100 may generate image data with reduced distortion, by correcting the rolling shutter data based on the hybrid shutter data, when the hybrid pixel units operate based on the second mode signal (i.e., when the hybrid pixel units operate in the global shutter manner). This will be described in detail with reference to FIGS. 13 to 16 and 21.

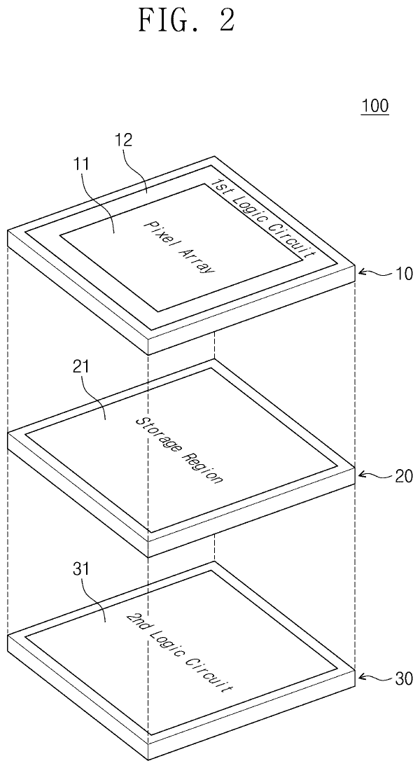

FIG. 2 is a diagram describing the image sensor 100 according to some embodiments. Referring to FIG. 2, the image sensor 100 having a multi-layer structure is illustrated. The image sensor 100 of FIG. 2 corresponds to the image sensor 100 of FIG. 1.

The image sensor 100 may include a first layer 10, a second layer 20, and a third layer 30. The first to third layers 10, 20, and 30 may be stacked in a vertical direction. For example, the second layer 20 may be disposed between the first layer 10 and the third layer 30.

In some embodiments, the first layer 10 may include a pixel array 11 and a first logic circuit 12. The pixel array 11 corresponds to the pixel array 110 of FIG. 1. The first logic circuit 12 may include circuits for driving the pixel array 11. For example, the first logic circuit 12 may include a row driver which drives row lines of FIG. 1, a readout circuit which obtains an output voltage from a pixel array through column lines, control logic which controls the row driver and the readout circuit, etc.

In some embodiments, the pixel array 11 may be disposed in a first region of the first layer 10, and the first logic circuit 12 may be disposed in a second region surrounding the first region.

The second layer 20 may include a storage region 21. The storage region 21 may include a plurality of capacitors. Each capacitor may be connected to the pixel units of the pixel array 11 formed in the first layer 10 or the first logic circuit 12.

The third layer 30 may include a second logic circuit 31. The second logic circuit 31 may include circuits for driving the pixel array 11 and the first logic circuit 12.

In some embodiments, the second logic circuit 31 may include a power circuit, an input/output interface, an image signal processor, etc.

In some embodiments, the second logic circuit 31 may be connected to the plurality of capacitors of the storage region 21 in the second layer 20.

In some embodiments, the first logic circuit 12 may be disposed in the third layer 30, not the first layer 10.

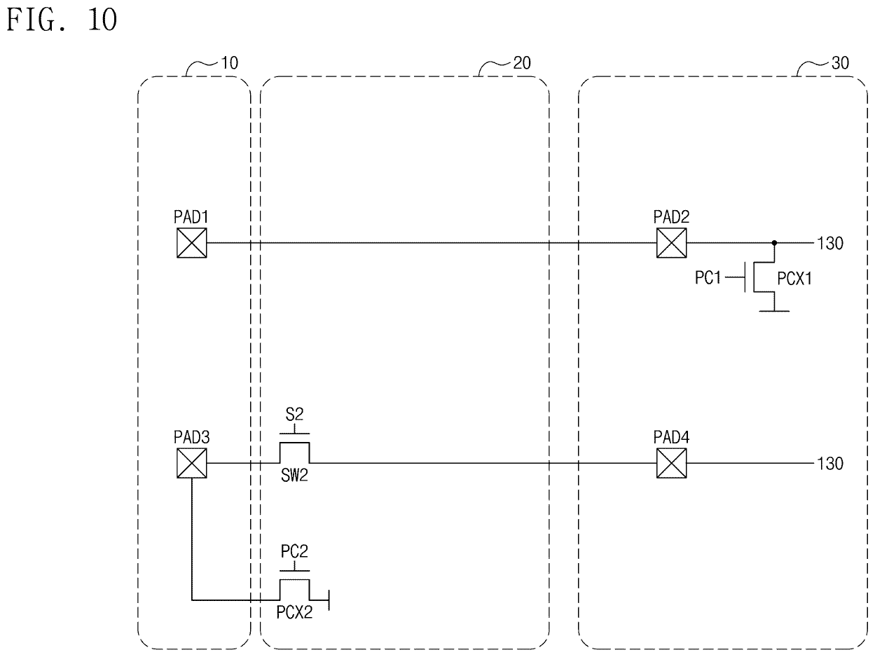

In some embodiments, a pre-charge circuit (e.g., a pre-charge transistor) of the rolling pixel unit of the pixel array 11 may be included in the third layer 30. A pre-charge circuit (e.g., a pre-charge transistor) of the hybrid pixel unit of the pixel array 11 may be included in the second layer 20. This will be described in detail with reference to FIG. 10.

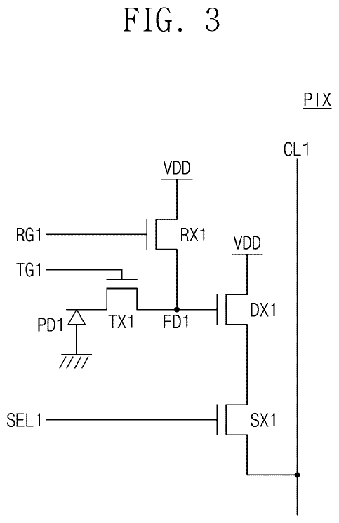

FIG. 3 is a circuit diagram of a rolling pixel unit PIX of FIG. 1. The rolling pixel unit PIX may include a first photodiode PD1, a first transfer transistor TX1, a first floating diffusion region FD1, a first reset transistor RX1, a first drive transistor DX1, and a first select transistor SX1.

The first photodiode PD1 may convert an incident light into a charge. For example, the first photodiode PD1 may generate a charge corresponding to the intensity or the amount of the incident light.

The first reset transistor RX1 may be turned on or turned off by a first reset signal RG1. When the first reset transistor RX1 is turned on, a voltage of the first floating diffusion region FD1 may be reset to a power supply voltage VDD. For example, when the voltage of the first floating diffusion region FD1 is reset and the first select transistor SX1 is turned on by a first selection signal SEL1, a reset voltage may be output to a first column line CL1.

After the reset voltage is output to the first column line CL1, when the first transfer transistor TX1 is turned on by a first transfer signal TG1, the charge generated when the first photodiode PD1 is exposed to the light may be transferred to the first floating diffusion region FD1. The first drive transistor DX1 may operate as a source follower amplifier amplifying the voltage of the first floating diffusion region FD1; when the first select transistor SX1 is turned on by the first selection signal SEL1, a pixel voltage corresponding to a charge generated by the first photodiode PD1 may be output to the first column line CL1.

In other words, the rolling pixel unit PIX may transfer the charge generated by the first photodiode PD1 to the first floating diffusion region FD1 and may amplify the charge of the first floating diffusion region FD1 (or may amplify a voltage corresponding to the amount of charge of the first floating diffusion region FD1) so as to be output to the first column line CL1 as an output voltage.

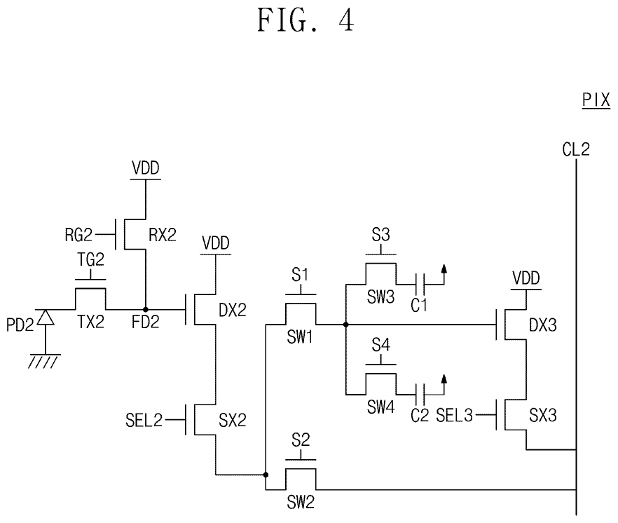

FIG. 4 is a circuit diagram of the hybrid pixel unit PIX of FIG. 1.

The hybrid pixel unit PIX may include a second photodiode PD2, a second transfer transistor TX2, a second floating diffusion region FD2, a second reset transistor RX2, a second drive transistor DX2, a second select transistor SX2, first to fourth switch transistors SW1 to SW4, a first capacitor C1, a second capacitor C2, a third drive transistor DX3, and a third select transistor SX3.

The hybrid pixel unit PIX may operate in the rolling shutter manner or the global shutter manner based on the mode signal.

For example, the hybrid pixel unit PIX may operate based on the first mode signal such that the first switch transistor SW1 is turned off by a first switch signal S1 and the second switch transistor SW2 is turned on by a second switch signal S2.

In this case, the second photodiode PD2, the second transfer transistor TX2, the second floating diffusion region FD2, the second reset transistor RX2, the second drive transistor DX2, the second select transistor SX2, and a second column line CL2 may respectively correspond to the first photodiode PD1, the first transfer transistor TX1, the first floating diffusion region FD1, the first reset transistor RX1, the first drive transistor DX1, the first select transistor SX1, and the first column line CL1 shown in FIG. 3 and may operate as described above.

Based on the first mode signal, the hybrid pixel unit PIX may transfer the charge generated by the second photodiode PD2 to the second floating diffusion region FD2 and may amplify a voltage corresponding to the charge of the second floating diffusion region FD2 so as to be output to the second column line CL2 as an output voltage.

In contrast, the hybrid pixel unit PIX may operate based on the second mode signal such that the first switch transistor SW1 is turned on by the first switch signal S1 and the second switch transistor SW2 is turned off by the second switch signal S2.

In this case, the hybrid pixel unit PIX may turn on the second reset transistor RX2 to reset the second floating diffusion region FD2. The charge of the second floating diffusion region FD2 thus reset may be amplified, and the charge corresponding to the amplified voltage (i.e., the reset voltage) may be transferred to (i.e., may be stored in) one of the first capacitor C1 and the second capacitor C2. For example, the third switch transistor SW3 may be turned on by a third switch signal S3, and the fourth switch transistor SW4 may be turned off by a fourth switch signal S4. That is, the charge may be stored in the first capacitor C1.

Afterwards, the charge may be generated by the second photodiode PD2 exposed to the light during an exposure time. The second transfer transistor TX2 may be turned on a second transfer signal TG2, and the charge generated by the second photodiode PD2 may be transferred to the second floating diffusion region FD2. A charge corresponding to the pixel voltage obtained by amplifying the charge of the second floating diffusion region FD2 may be stored in the second capacitor C2 through the fourth switch transistor SW4. In this case, the third switch transistor SW3 may be turned off.

In addition, when the readout operation is performed, the third switch transistor SW3 may be turned on, and the charge stored in the first capacitor C1 may be amplified to be output to the second column line CL2 as a reset voltage. Next, the fourth switch transistor SW4 may be turned on, and the charge stored in the second capacitor C2 may be amplified to be output to the second column line CL2 as a pixel voltage.

The first capacitor C1 and the second capacitor C2 may be included in the storage region 21 of FIG. 2. The hybrid pixel unit PIX which includes two capacitors C1 and C2 is illustrated in FIG. 4, but the present disclosure is not limited thereto. The number of capacitors may be one or may be three or more. For example, when three capacitors are provided, the third capacitor may store the charge associated with an auto-focusing operation.

FIG. 5 is a diagram describing a rolling shutter manner.

In the rolling shutter manner, an image sensor may sequentially perform a reset operation and a readout operation on target pixel units in units of row (or in units of pixel unit).

FIG. 6 is a diagram describing a global shutter manner.

In the global shutter manner, signals photoelectrically converted by photodiodes respectively included in all pixel units (hereinafter referred to as “target pixel units”) of a target region may be simultaneously transferred to floating diffusion nodes; afterwards, a digital signal of a pixel corresponding to each row (or pixel units) sequentially selected may be output.

In the global shutter manner, an image sensor may simultaneously reset the target pixel units and may simultaneously transfer the charge corresponding to the light received by the photodiodes to the floating diffusion nodes during the same time period. Afterwards, as the rows are sequentially selected, pixel signals of the target pixel units may be sequentially read out.

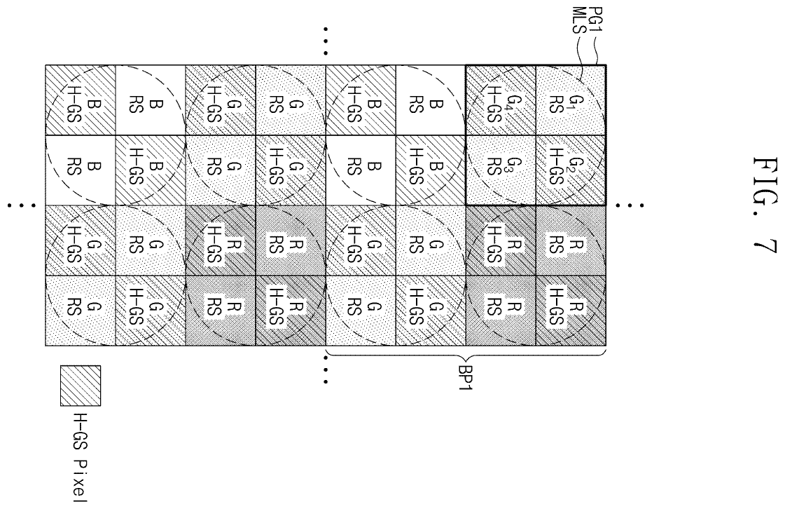

FIG. 7 is a diagram illustrating a pixel array according to some embodiments. Referring to FIG. 7, a pixel array may correspond to the pixel array 110 of FIG. 1. The pixel array may include a plurality of pixel groups. Each pixel group may include four pixel units arranged in a matrix with two rows and two columns.

The four pixel groups may be arranged in a matrix with two rows and two columns to form a Bayer pattern. Each pixel unit of a pixel group disposed at the first row and first column may include a green color filter. Each pixel unit of a pixel group disposed at the first row and second column may include a red color filter. Each pixel unit of a pixel group disposed at the second row and first column may include a blue color filter. Each pixel unit of a pixel group disposed at the second row and second column may include a green color filter.

For example, each of pixel units G₁ to G₄ of a first pixel group PG1 included in a first Bayer pattern BP1 may include the green color filter. The pixel units G₁ to G₄ may be disposed under the same micro lens MLS. For example, the first pixel unit G₁ may be disposed at the first row and first column, the second pixel unit G₂ may be disposed at the first row and second column, the third pixel unit G₃ may be disposed at the second row and second column, and the fourth pixel unit G₄ may be disposed at the second row and first column.

In some embodiments, four pixel units included in one pixel group may be disposed under one color filter or may be respectively disposed under four color filters having the same color. For example, the first to fourth pixel units G₁ to G₄ may be disposed under a first color filter or may be respectively disposed under first to fourth color filters having the green color.

In some embodiments, each of the first pixel unit G₁ and the third pixel unit G₃ may be a rolling pixel unit RS. Each of the second pixel unit G₂ and the fourth pixel unit G₄ may be a hybrid pixel unit H-GS. A block with the diagonal line indicates the hybrid pixel unit H-GS.

In the pixel array, a pattern such as the first Bayer pattern BP1 may be repeated in each of the up, down, left, and right directions.

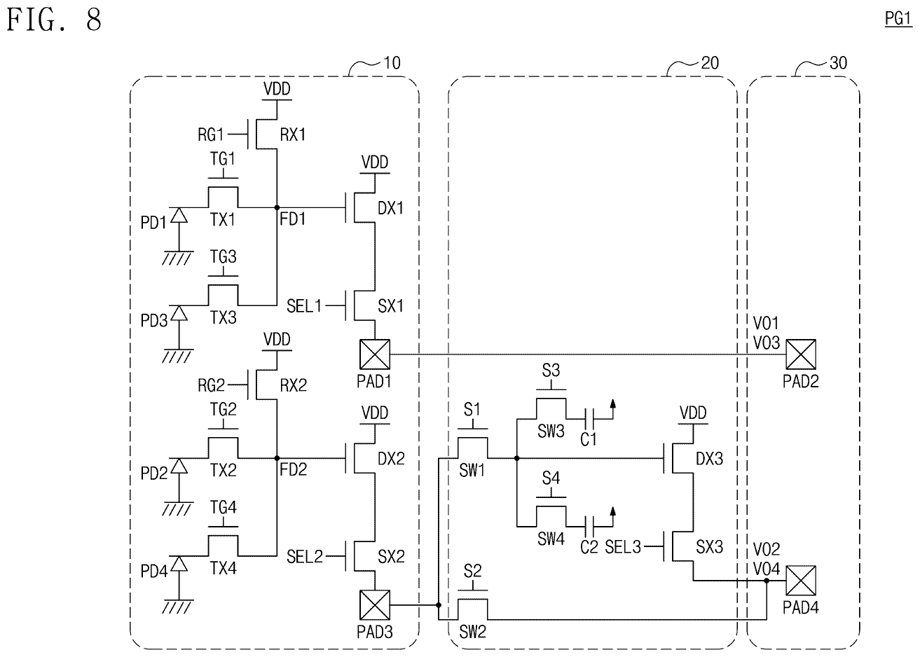

FIG. 8 is a circuit diagram of the first pixel group PG1 according to some embodiments. Referring to FIG. 8, the first pixel group PG1 may include first to fourth photodiodes PD1 to PD4, a first output circuit, and a second output circuit.

The first to fourth photodiodes PD1 to PD4 may be respectively included in four pixel units belonging to one pixel group. For example, the first photodiode PD1 may be included in the first pixel unit G₁ of FIG. 7. The second photodiode PD2 may be included in the second pixel unit G₂ of FIG. 7. The third photodiode PD3 may be included in the third pixel unit G₃ of FIG. 7. The fourth photodiode PD4 may be included in the fourth pixel unit G₄ of FIG. 7.

At least some of pixel units included in the same pixel group may share a floating diffusion region and some transistors. This will be described in detail later.

A first pixel unit and a third pixel unit may share the first output circuit.

The first output circuit may transfer a first charge generated by the first photodiode PD1 to the first floating diffusion region FD1 and may amplify the charge of the first charge transferred to the first floating diffusion region FD1 to be output as a first output voltage VO1. Also, the first output circuit may transfer a third charge generated by the third photodiode PD3 to the first floating diffusion region FD1 and may amplify the charge of the third charge transferred to the first floating diffusion region FD1 to be output as a third output voltage VO3.

In some embodiments, the first output circuit may operate in the rolling shutter manner. In other words, a series of operations (e.g., the reset operation and the readout operation) on the first photodiode PD1 and the third photodiode PD3 connected to the first output circuit may be sequentially performed by the first output circuit. This will be described in detail with reference to FIG. 11.

In some embodiments, the first output circuit may include the first transfer transistor TX1, the first reset transistor RX1, the first floating diffusion region FD1, the first drive transistor DX1, and the first select transistor SX1. The first transfer transistor TX1, the first reset transistor RX1, the first floating diffusion region FD1, the first drive transistor DX1, and the first select transistor SX1 may respectively correspond to components having the same reference signs as illustrated in FIG. 3 The first output voltage VOI thus read out and the third output voltage VO3 thus read out may be provided to an ADC circuit through a first pad PAD1 and a second pad PAD2.

In some embodiments, the first output circuit may be disposed in the first layer 10 (i.e., the first layer 10 of FIG. 2). The first pad PAD1 may be disposed in the first layer 10 and may be connected to the second pad PAD2 disposed in the third layer 30 (i.e., the third layer 30 of FIG. 2). Although not illustrated, a pre-charge circuit (e.g., a pre-charge transistor) of the first output circuit may be disposed in the third layer 30, which will be described in detail with reference to FIG. 10.

The second pixel unit and the fourth pixel unit may share the second output circuit.

The second output circuit may operate based on the first mode signal as follows. The second output circuit may transfer a second charge generated by the second photodiode PD2 to the second floating diffusion region FD2. The second output circuit may amplify the second charge transferred to the second floating diffusion region FD2 to be output as a second output voltage VO2. Also, the second output circuit may transfer a fourth charge generated by the fourth photodiode PD4 to the second floating diffusion region FD2. The second output circuit may amplify the fourth charge transferred to the second floating diffusion region FD2 to be output as a fourth output voltage VO4.

In some embodiments, the first mode signal may correspond in the rolling shutter manner.

The second output circuit may operate based on the second mode signal as follows. The second output circuit may amplify the second charge generated by the second photodiode PD2 and may store a first amplified charge in a storage region. The first amplified charge may indicate a charge corresponding to a voltage obtained by amplifying the second charge by using the second drive transistor DX2. The second output circuit may amplify the first amplified charge stored in the storage region to output the second output voltage VO2. Also, the second output circuit may amplify the fourth charge generated by the fourth photodiode PD4 and may store a second amplified charge in a storage region. The second amplified charge may indicate a charge corresponding to a voltage obtained by amplifying the fourth charge by using the second drive transistor DX2. The second output circuit may amplify the second amplified charge stored in the storage region to output the fourth output voltage VO4.

In some embodiments, the second mode signal may correspond to the global shutter manner.

In some embodiments, the second output circuit may include the second transfer transistor TX2, the second reset transistor RX2, the second floating diffusion region FD2, the second drive transistor DX2, the second select transistor SX2, the first to fourth switch transistors SW1 to SW4, the first capacitor C1, the second capacitor C2, the third drive transistor DX3, and the third select transistor SX3. The components of the second output circuit may respectively correspond to components having the same reference signs as illustrated in FIG. 4. The second output voltage VO2 (e.g., the reset voltage or the pixel voltage) thus read out and the fourth output voltage VO4 thus read out may be provided to the ADC circuit through a fourth pad PAD4.

In some embodiments, the second transfer transistor TX2, the second reset transistor RX2, the second floating diffusion region FD2, the second drive transistor DX2, and the second select transistor SX2 of the second output circuit may be disposed in the first layer 10. The first to fourth switch transistors SW1 to SW4, the first capacitor C1, the second capacitor C2, the third drive transistor DX3, and the third select transistor SX3 of the second output circuit may be disposed in the second layer 20 (i.e., the second layer 20 of FIG. 2). A third pad PAD3 may be disposed in the first layer 10 and may be connected to circuit elements of the second layer 20. The fourth pad PAD4 may be disposed in the third layer 30. Although not illustrated, a pre-charge circuit (e.g., a pre-charge transistor) of the second output circuit may be disposed in the second layer 20, which will be described in detail with reference to FIG. 10.

FIG. 9 is a block diagram illustrating the ADC circuit 130 and the image signal processor 150 of FIG. 1 in detail. The image signal processor 150 may include a luminance data generator 151, an image arranging device 152, and a correction device 153.

The ADC circuit 130 may receive the first output voltage VOI from the first output circuit of FIG. 8. The ADC circuit 130 may receive the second output voltage VO2 from the second output circuit of FIG. 8.

The ADC circuit 130 may generate first to fourth digital signals DS1 to DS4 respectively corresponding to the first to fourth pixel units based on the first output voltage VO1 and the second output voltage VO2. For example, the first to fourth digital signals DS1 to DS4 may respectively correspond to the first to fourth output voltages VO1 to VO4 of FIG. 8. That is, the ADC circuit 130 may convert the first to fourth output voltages VO1 to VO4 into the first to fourth digital signals DS1 to DS4, respectively.

The luminance data generator 151 may receive the first to fourth digital signals DS1 to DS4 from the ADC circuit 130. The luminance data generator 151 may generate luminance data LD based on the first to fourth digital signals DS1 to DS4. The luminance data LD may include a set of luminance values corresponding to a first pixel group. For example, the luminance data LD may include all the first to fourth luminance values respectively corresponding to the first to fourth digital signals DS1 to DS4. The luminance data LD may have a matrix format including first to fourth luminance values and dummy values. This will be described in detail with reference to FIG. 11. The luminance data generator 151 may provide the luminance data LD to the image arranging device 152.

The image arranging device 152 may receive the luminance data LD from the luminance data generator 151. The image arranging device 152 may receive position information PI from the control circuit 140 of FIG. 1. The position information PI may indicate information about positions of pixels respectively corresponding to the first to fourth luminance data (or the first to fourth digital signals DS1 to DS4). For example, the position information PI may indicate that the first luminance data (or the first digital signal DS1) corresponds to a position of the first row and first column of the first pixel group, the second luminance data (or the second digital signal DS2) corresponds to a position of the first row and second column of the first pixel group, the third luminance data (or the third digital signal DS3) corresponds to a position of the second row and second column of the first pixel group, and the fourth luminance data (or the fourth digital signal DS4) corresponds to a position of the second row and first column of the first pixel group.

In this case, the image arranging device 152 may generate image data IMG based on the luminance data LD and the position information PI, by arranging the luminance values depending on the position information PI. The image arranging device 152 may provide the image data IMG to the correction device 153.

The correction device 153 may extract a correction parameter based on the image data IMG and may correct the image data IMG based on the correction parameter to be output as the processed signal PS.

The correction device 153 may receive a mode signal MS from the control circuit 140 of FIG. 1. The correction device 153 may receive a first mode signal MS1 or a second mode signal MS2. The correction device 153 may receive the same mode signal as a mode signal which forms the basis for an operation of the first pixel group.

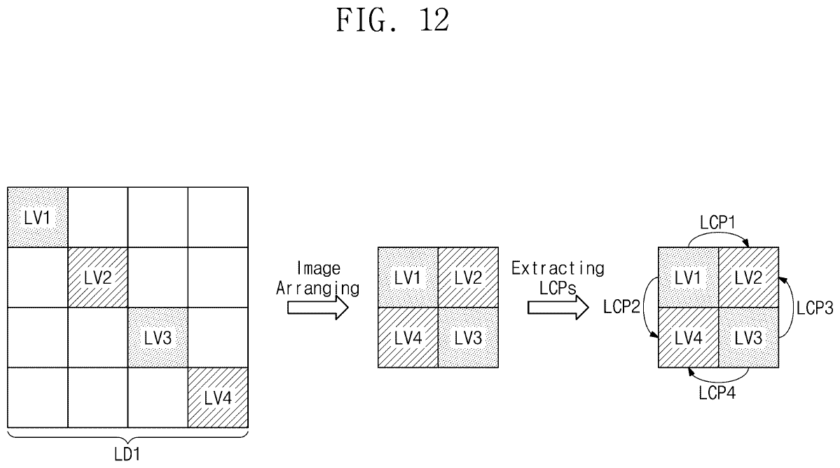

Based on the first mode signal MS1, the correction device 153 may provide the image data IMG to a luminance correction parameter (LCP) extractor. The luminance correction parameter (LCP) extractor may extract a luminance correction parameter LCP by comparing at least two luminance values of the image data IMG. For example, the correction device 153 may calculate luminance offset values of luminance values of hybrid shutter data based on luminance values of rolling shutter data. The luminance correction parameter LCP may include the luminance offset values (or may be the luminance offset values). The correction device 153 may correct luminance values of the hybrid shutter data based on the luminance correction parameter LCP. This will be described in detail with reference to FIG. 12.

Based on the second mode signal MS2, the correction device 153 may provide the image data IMG to a position correction parameter (PCP) extractor. The position correction parameter (PCP) extractor may extract a position correction parameter PCP based on the image data IMG. For example, the position correction parameter (PCP) extractor may calculate position offset values of the rolling shutter data based on position information of the hybrid shutter data. Based on positions in the image data IMG, at which the luminance values of the hybrid shutter data are disposed, the position correction parameter (PCP) extractor may generate the position offset values based on a difference of positions in the image data IMG, at which the luminance values of the rolling shutter data are disposed. The position correction parameter PCP may include the position offset values (or may be the position offset values).

In some embodiments, the position correction parameter (PCP) extractor may calculate the position difference by using differencing.

In some embodiments, the position correction parameter (PCP) extractor may generate the position correction parameter PCP by handling the position offset values as a motion vector.

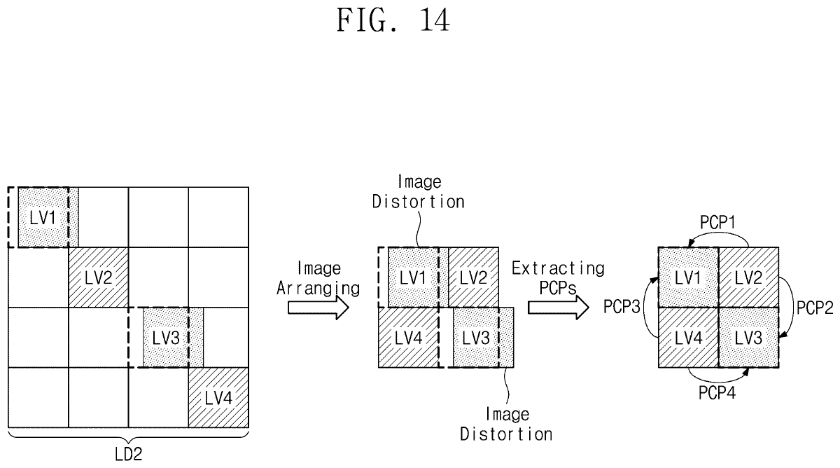

The position correction parameter (PCP) extractor may correct position information of the rolling pixel data based on the position correction parameter PCP. That is, the position correction parameter (PCP) extractor may correct positions in the image data IMG, at which luminance values of the rolling pixel data are disposed. This will be described in detail with reference to FIG. 14.

In other words, when the first mode signal MS1 is provided to the image signal processor 150, the image signal processor 150 may correct the hybrid shutter data based on the rolling shutter data. In terms of the quality of image of the processed signal PS, the quality of image may be improved by correcting the hybrid shutter data based on the rolling shutter data. This will be described in detail with reference to FIG. 10.

In contrast, when the second mode signal MS2 is provided to the image signal processor 150, the image signal processor 150 may correct the rolling shutter data based on the hybrid shutter data. In terms of image distortion of the processed signal PS, the image distortion may further decrease by correcting the hybrid shutter data based on the rolling shutter data.

That is, when the image sensor operates based on the first mode signal (e.g., in a mode for obtaining a high-definition image signal), to improve the quality of image, the hybrid shutter data may be corrected based on the rolling shutter data (i.e., the hybrid pixel units may operate in the rolling shutter mode). Also, when the image sensor operates based on the second mode signal (e.g., in a mode for obtaining an image signal with low distortion such as video photography or a preview image), to reduce the distortion, the rolling shutter data may be corrected based on the hybrid shutter data (i.e., the hybrid pixel units may operate in the global shutter mode).

FIG. 10 is a circuit diagram illustrating pre-charge circuits of the first pixel group PG1 of FIG. 8 in detail. Referring to FIG. 10, a first pre-charge transistor PCX1 connected to the first output circuit (or included in the first output circuit) of FIG. 8 and a second pre-charge transistor PCX2 connected to the second output circuit (or included in the second output circuit) of FIG. 8 are illustrated. The first pad PAD1, the second pad PAD2, the third pad PAD3, the second switch transistor SW2, the fourth pad PAD4, the first layer 10, the second layer 20, and the third layer 30 respectively correspond to components having the same reference signs as illustrated in FIG. 8.

For convenience of description, only circuit components directly connected to pre-charge circuits from among the circuit components are illustrated in FIG. 10.

The first pre-charge transistor PCX1 may be connected between the second pad PAD2 and a current source. The first pre-charge transistor PCX1 may be turned on or turned off by a first pre-charge signal PC1. When the first pre-charge transistor PCX1 is turned on, a load current may be provided to a first drive transistor of the first output circuit.

In some embodiments, the first pre-charge transistor PCX1 may be disposed in the third layer 30.

The second pre-charge transistor PCX2 may be connected between the third pad PAD3 and the current source. The second pre-charge transistor PCX2 may be turned on or turned off by a second pre-charge signal PC2. When the second pre-charge transistor PCX2 is turned on, a load current may be provided to a second drive transistor of the second output circuit.

In some embodiments, the second pre-charge transistor PCX2 may be disposed in the second layer 20. The width and the length of the second pre-charge transistor PCX2 may be smaller than the width and the length of the first pre-charge transistor PCX1. For example, due to the influence of an NMOS transistor and the limited area, the second pre-charge transistor PCX2 disposed in the second layer 20 may be smaller in size than the first pre-charge transistor PCX1 disposed in the third layer 30.

This may mean that the first pre-charge transistor PCX1 has a low probability of occurrence of degradation and a low probability of current fluctuations compared to the second pre-charge transistor PCX2.

Accordingly, the image sensor according to some embodiments may correct luminance values corresponding to the hybrid pixel units based on luminance values corresponding to the rolling pixel units to improve the quality of image of the processed signal.

FIG. 11 is a diagram describing an operation of the first pixel group PG1 of FIG. 7. Referring to FIG. 11, a timing diagram for describing how the first to fourth pixel units G₁ to G₄ in the first pixel group PG1 operate based on the first mode signal is schematically illustrated.

The reset operation and the readout operation on rolling pixel units (e.g., the first pixel unit G₁ and the third pixel unit G₃) may be sequentially performed. For example, the reset operation on the first pixel unit G₁ may be started at a first time point t1. The reset operation on the third pixel unit G₃ may be started at a second time point t2.

Hybrid pixel units (e.g., the second pixel unit G₂ and the fourth pixel unit G₄) may operate in the rolling shutter manner based on the first mode signal. In other words, the reset operation and the readout operation on the second pixel unit G₂ and the fourth pixel unit G₄ may be sequentially performed. Because the readout path of the hybrid pixel units is different from the readout path of the rolling pixel units, the hybrid pixel units and the rolling pixel units may operate at independent timings. For example, the reset operation on the second pixel unit G₂ may be started at the first time point t1. The reset operation on the fourth pixel unit G₄ may be started at the second time point t2. However, the present disclosure is not limited thereto. For example, the second pixel unit G₂ may initiate the reset operation at a time point different from the first time point t1 (e.g., a time point before or after the first time point t1). Also, the fourth pixel unit G₄ may initiate the reset operation at a time point different from the second time point t2.

In this case, first to fourth luminance values LV1 to LV4 may be respectively generated based on the readout operations on the first to fourth pixel units G₁ to G₄.

FIG. 12 is a diagram describing a method in which the image signal processor 150 of FIG. 1 operates based on the first mode signal, according to some embodiments. A method in which an image signal processor corrects hybrid shutter data based on rolling shutter data will be described with reference to FIG. 12.

The image signal processor 150 may generate first luminance data LD1 based on the first to fourth luminance values LV1 to LV4 respectively corresponding to the first to fourth pixel units. The first luminance data LD1 is illustrated in the form of a matrix including four rows and four columns. The first luminance value LV1 may be disposed at the first row and first column. The second luminance value LV2 may be disposed at the second row and second column. The third luminance value LV3 may be disposed at the third row and third column. The fourth luminance value LV4 may be disposed at the fourth row and fourth column. Dummy values may be disposed at the remaining rows and the remaining columns. However, the present disclosure is not limited thereto. The number of rows and the number of columns may be different from those described above, and the arrangement of luminance values may be different from those described above.

The image signal processor 150 may generate image data by rearranging pixel values based on position information. In some embodiments, each pixel value may be disposed at a corresponding pixel unit position in a pixel array. For example, the first luminance value LV1 may be disposed at the first row and first column, the second luminance value LV2 may be disposed at the first row and second column, the third luminance value LV3 may be disposed at the second row and second column, and the fourth luminance value LV4 may be disposed at the second row and first column.

The image signal processor 150 may extract luminance correction parameters LCP1 to LCP4 associated with the hybrid shutter data based on the rolling shutter data.

The image signal processor 150 may generate the first luminance correction parameter LCP1 associated with the second luminance value LV2 based on the first luminance value LV1. The image signal processor 150 may generate the second luminance correction parameter LCP2 associated with the fourth luminance value LV4 based on the first luminance value LV1.

The image signal processor 150 may generate the third luminance correction parameter LCP3 associated with the second luminance value LV2 based on the third luminance value LV3 and may generate the fourth luminance correction parameter LCP4 associated with the fourth luminance value LV4 based on the third luminance value LV3.

The image signal processor 150 may correct the second luminance value LV2 based on the first luminance correction parameter LCP1 and the third luminance correction parameter LCP3. The image signal processor 150 may correct the fourth luminance value LV4 based on the second luminance correction parameter LCP2 and the fourth luminance correction parameter LCP4.

FIG. 13 is a diagram describing an operation of the first pixel group PG1 of FIG. 7. Referring to FIG. 13, a timing diagram for describing how the first to fourth pixel units G₁ to G₄ in the first pixel group PG1 operate based on the second mode signal is schematically illustrated.

The reset operation and the readout operation on rolling pixel units (e.g., the first pixel unit G₁ and the third pixel unit G₃) may be sequentially performed. For example, the reset operation on the first pixel unit G₁ may be started at a first time point t1. The reset operation on the third pixel unit G₃ may be started at a second time point t2.

Hybrid pixel units (e.g., the second pixel unit G₂ and the fourth pixel unit G₄) may operate in the global shutter manner based on the second mode signal. In other words, the reset operations on the second pixel unit G₂ and the fourth pixel unit G₄ may be simultaneously performed, but afterwards, the readout operations on the second pixel unit G₂ and the fourth pixel unit G₄ may be sequentially performed. Because the readout path of the hybrid pixel units is different from the readout path of the rolling pixel units, the hybrid pixel units and the rolling pixel units may operate at independent timings.

For example, the reset operation on the second pixel unit G₂ and the reset operation on the fourth pixel unit G₄ may be simultaneously started at the first time point t1. However, the readout operation on the second pixel unit G₂ may be started at a third time point t3, and the readout operation on the fourth pixel unit G₄ may be started at a fourth time point t4 following the third time point t3. However, the present disclosure is not limited thereto. For example, the second pixel unit G₂ may initiate the reset operation at a time point different from the first time point t1 (e.g., a time point before or after the first time point t1). Also, the fourth pixel unit G₄ may initiate the reset operation at a time point different from the second time point t2.

In some embodiments, the readout operation of the third pixel unit G₃ may be first initiated at a time point before the fourth time point t4. The reason is that the exposure time of the global shutter manner is longer than the exposure time of the rolling shutter manner.

In this case, the first to fourth luminance values LV1 to LV4 may be respectively generated based on the readout operations on the first to fourth pixel units G₁ to G₄.

FIG. 14 is a diagram describing a method in which the image signal processor 150 of FIG. 1 operates based on the second mode signal, according to an embodiment of the present disclosure. A method in which an image signal processor corrects rolling shutter data based on hybrid shutter data will be described with reference to FIG. 14.

The image signal processor 150 may generate second luminance data LD2 based on the first to fourth luminance values LV1 to LV4. Also, the image signal processor 150 may generate pixel data by rearranging luminance values based on the second luminance data LD2 and position information. For convenience, the description which is given with reference to FIG. 12 will be omitted to avoid redundancy.

In this case, in the second luminance data LD2 and the pixel data, an error may exist at positions where the first luminance value LV1 and the third luminance value LV3 corresponding to the rolling pixel units are disposed. Referring to FIG. 14, original positions of the first luminance value LV1 and the third luminance value LV3 are marked by a dotted line, and positions of the first luminance value LV1 and the third luminance value LV3 are displaced due to the error are marked by a bold solid line.

The position displacement may correspond to image distortion and may occur because pixel units operating depending on the rolling shutter manner are sequentially (not simultaneously) exposed to the light.

The image signal processor 150 may extract position correction parameters PCP1 to PCP4 associated with the rolling shutter data based on the hybrid shutter data.

For example, when the second mode signal is provided to the image signal processor 150, the image signal processor 150 may correct positions at which the first luminance value LV1 and the third luminance value LV3 are disposed, based on positions where the second luminance value LV2 and the fourth luminance value LV4 are disposed.

The image signal processor 150 may calculate a position offset value associated with a position where the first luminance value LV1 is disposed, based on the second luminance value LV2 (i.e., based on information about a position where the second luminance value LV2 is disposed). The image signal processor 150 may generate the first position correction parameter PCP1 based on the position offset value. The image signal processor 150 may generate the second position correction parameter PCP2 associated with the third luminance value LV3 based on the second luminance value LV2.

The image signal processor 150 may generate the third position correction parameter PCP3 associated with the first luminance value LV1 based on the fourth luminance value LV4 and may generate the fourth position correction parameter PCP4 associated with the third luminance value LV3 based on the fourth luminance value LV4.

The image signal processor 150 may correct a position where the first luminance value LV1 is disposed, based on the first position correction parameter PCP1 and the third position correction parameter PCP3. The image signal processor 150 may correct a position where the third luminance value LV3 is disposed, based on the second position correction parameter PCP2 and the fourth position correction parameter PCP4 (in FIG. 14, a dotted line and a bold solid line coincide with each other after correction).

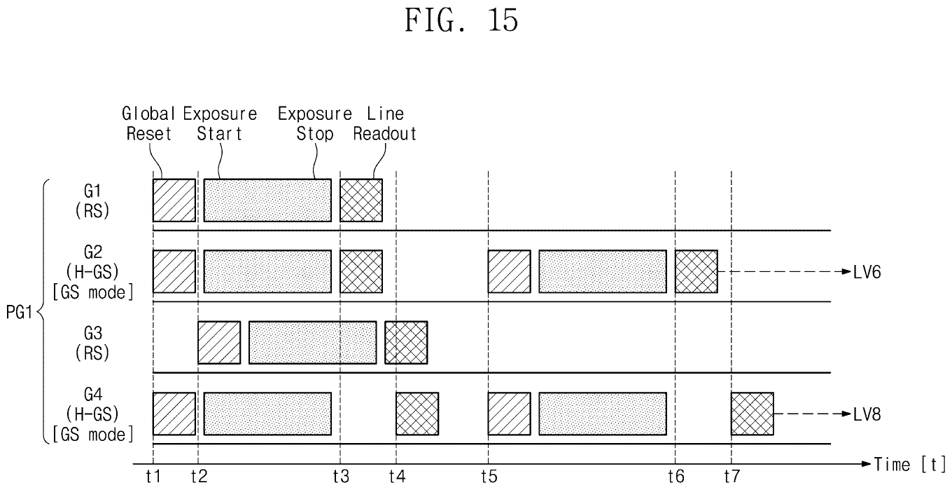

FIG. 15 is a diagram describing an operation of a first pixel group of FIG. 7. Referring to FIG. 15, a timing diagram corresponding to an embodiment where additional operations on hybrid pixel units are performed based on the second mode signal after the operations illustrated in FIG. 14.

Operations from a first time point t1 to a fourth time point t4 are the same as those of FIG. 13. For convenience, the description which is given with reference to FIG. 13 will be omitted to avoid redundancy.

After the fourth time point t4, at a fifth time point t5, additional operations on hybrid pixel units (e.g., the second pixel unit G₂ and the fourth pixel unit G₄) may be performed. The additional reset operations on the second pixel unit G₂ and the fourth pixel unit G₄ may be initiated at the fifth time point t5. The additional readout operation on the second pixel unit G₂ may be initiated at a sixth time point t6. The additional readout operation on the fourth pixel unit G₄ may be initiated at a seventh time point t7.

Additional output voltages may be provided to the ADC circuit by the additional readout operations on the second pixel unit G₂ and the fourth pixel unit G₄. The ADC circuit may convert the additional output voltage into an additional digital signal.

The image signal processor may generate additional luminance values based on the additional digital signal. The image signal processor may generate a sixth luminance value LV6 based on the additional output voltage corresponding to the second pixel unit G₂. The image signal processor may generate an eighth luminance value LV8 based on the additional output voltage corresponding to the fourth pixel unit G₄.

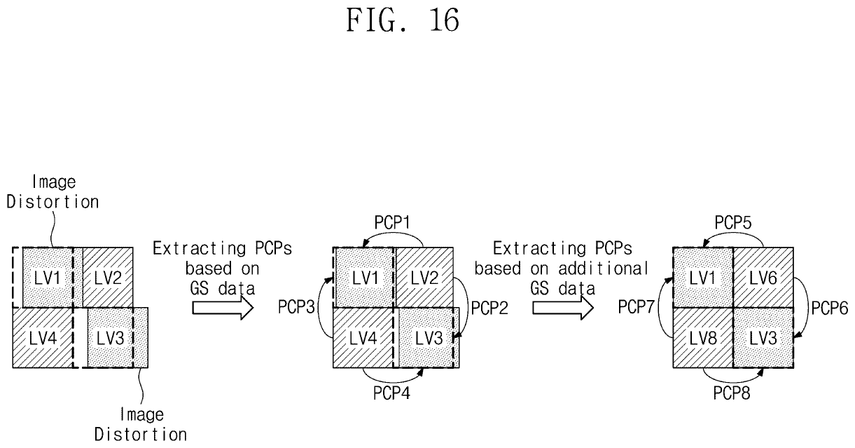

FIG. 16 is a diagram describing a method in which the image signal processor 150 of FIG. 1 operates based on the second mode signal, according to some embodiments. As described with reference to FIG. 16, a method in which an image signal processor corrects image data in a two-step manner when the additional luminance values LV6 and LV8 associated with hybrid pixel units are obtained is illustrated.

The image signal processor may rearrange the first to fourth luminance values LV1 to LV4 to generate image data (the same as the image data before the correction of FIG. 14). As in the above description given with respect to FIG. 14, the image signal processor may extract the position correction parameters PCP1 to PCP4 associated with the first luminance value LV1 and the third luminance value LV3 based on positions where the second luminance value LV2 and the fourth luminance value LV4 are disposed. The image signal processor may perform first correction for positions where the first luminance value LV1 and the third luminance value LV3 are disposed, based on the position correction parameters PCP1 to PCP4.

In addition, the image signal processor may dispose the corrected first luminance value LV1 at the first row and first column, may dispose the sixth luminance value LV6 at the first row and second column, may dispose the corrected third luminance value LV3 at the second row and second column, and may dispose the eighth luminance value LV8 at the second row and first column, and thus, the additional image data may be generated.

In this case, the image signal processor may correct positions at which the first luminance value LV1 and the third luminance value LV3 are disposed, based on positions where the sixth luminance value LV6 and the eighth luminance value LV8 are disposed.

The image signal processor may generate a fifth position correction parameter PCP5 associated with the corrected first luminance value LV1 based on the sixth luminance value LV6. The image signal processor may generate a sixth position correction parameter PCP6 associated with the corrected third luminance value LV3 based on the sixth luminance value LV6. The image signal processor 150 may generate a seventh position correction parameter PCP7 associated with the corrected first luminance value LV1 based on the eighth luminance value LV8. In the image signal processor may generate an eighth position correction parameter PCP8 associated with the corrected third luminance value LV3 based on the eighth luminance value LV8.

The image signal processor may correct a position where the corrected first luminance value LV1 will be disposed, once more based on the fifth position correction parameter PCP5 and the seventh position correction parameter PCP7. The image signal processor may correct a position where the corrected third luminance value LV3 will be disposed, once more based on the sixth position correction parameter PCP6 and the eighth position correction parameter PCP8.

Accordingly, the image sensor according to some embodiments may further reduce image distortion by correcting positions where luminance values corresponding to the rolling pixel units will be disposed, once more based on additional output voltages.

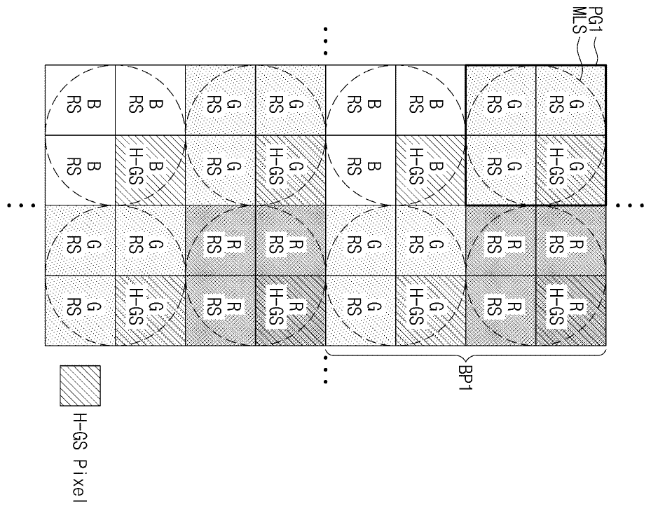

FIG. 17 is a diagram illustrating a pixel array according to some embodiments. As in the above description given with reference to FIG. 7, referring to FIG. 17, a pixel array in which one hybrid pixel unit is present in one pixel group is illustrated. The first Bayer pattern BP1, the first pixel group PG1, and the micro lens MLS of FIG. 17 respectively correspond to the first Bayer pattern BP1, the first pixel group PG1, and the micro lens MLS of FIG. 7.

For convenience, the description which is given with reference to FIG. 7 will be omitted to avoid redundancy.

The first pixel group PG1 may include three rolling pixel units RS and one hybrid pixel unit H-GS.

For example, the first pixel unit G₁ disposed at the first row and first column may be the rolling pixel unit RS. The third pixel unit G₃ disposed at the second row and second column may be the rolling pixel unit RS. The fourth pixel unit G₄ disposed at the second row and first column may be the rolling pixel unit RS. The second pixel unit G₂ disposed at the first row and second column may be the hybrid pixel unit H-GS.

However, the present disclosure is not limited thereto. For example, a position where the hybrid pixel unit H-GS is disposed may be variously changed. For example, the hybrid pixel unit H-GS may be disposed at the first row and first column.

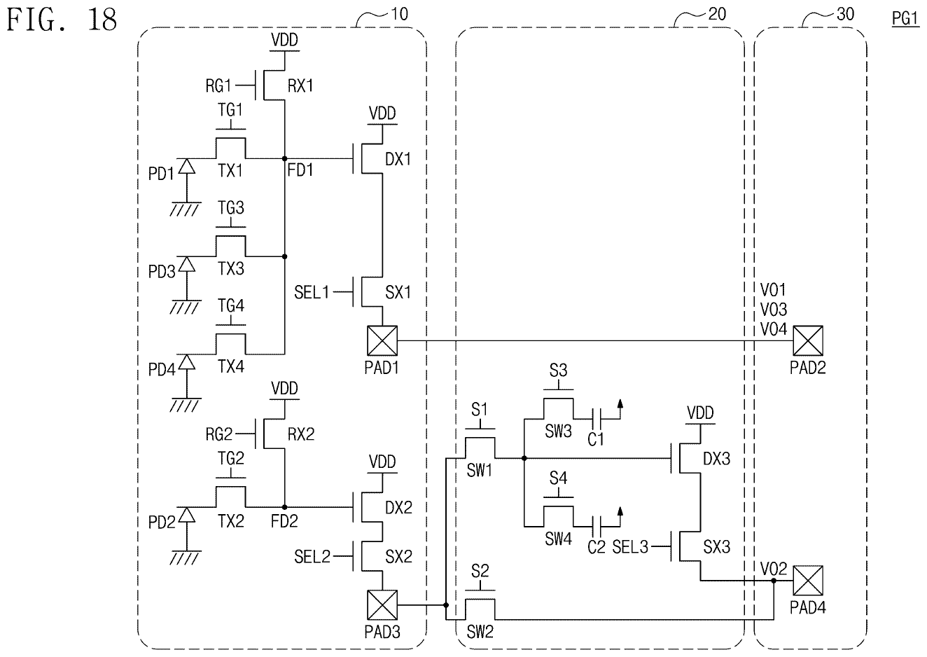

FIG. 18 is a circuit diagram of the first pixel group PG1 according to some embodiments. Referring to FIG. 18, the first pixel group PG1 may include the first to fourth photodiodes PD1 to PD4, the first output circuit, and the second output circuit.

The first to fourth photodiodes PD1 to PD4 may be respectively included in four pixel units belonging to one pixel group. For example, the first photodiode PD1 may be included in the first pixel unit G₁ of FIG. 17. The second photodiode PD2 may be included in the second pixel unit G₂ of FIG. 17. The third photodiode PD3 may be included in the third pixel unit G₃ of FIG. 17. The fourth photodiode PD4 may be included in the fourth pixel unit G₄ of FIG. 17.

At least some of pixel units included in the same pixel group may share a floating diffusion region and some transistors. This will be described in detail later.

A first pixel unit, a third pixel unit, and a fourth pixel unit may share the first output circuit.

The first output circuit may transfer a first charge generated by the first photodiode PD1 to the first floating diffusion region FD1 and may amplify the first charge transferred to the first floating diffusion region FD1 to be output as the first output voltage VO1. The first output circuit may transfer a third charge generated by the third photodiode PD3 to the first floating diffusion region FD1 and may amplify the third charge transferred to the first floating diffusion region FD1 to be output as the third output voltage VO3. The first output circuit may transfer a fourth charge generated by the fourth photodiode PD4 to the first floating diffusion region FD1 and may amplify the fourth charge transferred to the first floating diffusion region FD1 to be output as the fourth output voltage VO4.

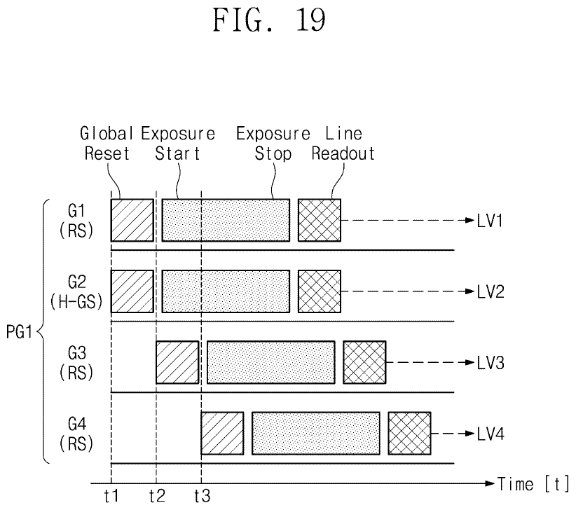

In some embodiments, the first output circuit may operate in the rolling shutter manner. In other words, the first output circuit may sequentially perform the reset operations and the readout operations associated with the first photodiode PD1, the third photodiode PD3, and the fourth photodiode PD4 connected to the first output circuit. This will be described in detail with reference to FIG. 19.

In some embodiments, the first output circuit may include the first transfer transistor TX1, the first reset transistor RX1, the first floating diffusion region FD1, the first drive transistor DX1, and the first select transistor SX1. The first transfer transistor TX1, the first reset transistor RX1, the first floating diffusion region FD1, the first drive transistor DX1, and the first select transistor SX1 may respectively correspond to components having the same reference signs as illustrated in FIG. 3 The first output voltage VO1 thus read out (e.g., the reset voltage or the pixel voltage) may be provided to an ADC circuit through the first pad PAD1 and the second pad PAD2.

The second pixel unit may include the second output circuit.

The second output circuit may operate based on the first mode signal as follows. The second output circuit may transfer a second charge generated by the second photodiode PD2 to the second floating diffusion region FD2. The second output circuit may amplify the second charge transferred to the second floating diffusion region FD2 to be output as the second output voltage VO2.

In some embodiments, the first mode signal may correspond in the rolling shutter manner.

The second output circuit may operate based on the second mode signal as follows. The second output circuit may amplify the second charge generated by the second photodiode PD2 and may store a first amplified charge in a storage region. The second output circuit may amplify the first amplified charge stored in the storage region to output the second output voltage VO2.

In some embodiments, the second mode signal may correspond to the global shutter manner.

In some embodiments, the second output circuit may include the second transfer transistor TX2, the second reset transistor RX2, the second floating diffusion region FD2, the second drive transistor DX2, the second select transistor SX2, the first to fourth switch transistors SW1 to SW4, the first capacitor C1, the second capacitor C2, the third drive transistor DX3, and the third select transistor SX3. The components of the second output circuit may respectively correspond to components having the same reference signs as illustrated in FIG. 4. The second output voltage VO2 thus read out (e.g., the reset voltage or the pixel voltage) may be provided to the ADC circuit through the fourth pad PAD4.

FIG. 19 is a diagram describing an operation of the first pixel group PG1 of FIG. 18. Referring to FIG. 19, a timing diagram for describing how the first to fourth pixel units G₁ to G₄ in the first pixel group PG1 operate is schematically illustrated.

The reset operations and the readout operations on rolling pixel units (e.g., the first pixel unit G1, the third pixel unit G₃, and the fourth pixel unit G₄) may be sequentially performed. For example, the reset operation on the first pixel unit G₁ may be started at a first time point t1. The reset operation on the third pixel unit G₃ may be started at a second time point t2. The reset operation on the fourth pixel unit G₄ may be started at a third time point t3.

The hybrid pixel unit (e.g., the second pixel unit G₂) may operate in the rolling shutter manner or the global shutter manner. The reset operation of the second pixel unit G₂ is illustrated as being started at the first time point t1, but the present disclosure is not limited thereto. Because the readout path of the hybrid pixel unit is different from the readout path of the rolling pixel units, the hybrid pixel unit and the rolling pixel units may operate at independent timings.

In some embodiments, the second pixel unit G₂ may operate in the global shutter manner based on the second mode signal. In this case, unlike the example illustrated in FIG. 19, the exposure time of the second pixel unit G₂ may be longer than the exposure time of the rolling pixel units.

As illustrated in FIG. 19, the first to fourth luminance values LV1 to LV4 may be respectively generated based on the readout operations on the first to fourth pixel units Gi to G₄.

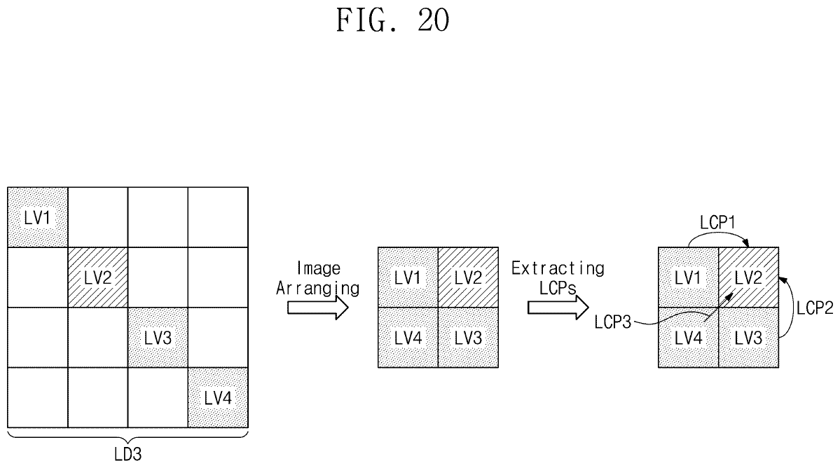

FIG. 20 is a diagram describing a method in which an image signal processor of FIG. 1 operates based on a first mode signal, according to some embodiments. A method in which an image signal processor corrects hybrid shutter data based on rolling shutter data in association with the luminance values LV1 to LV4 generated in FIG. 19 will be described with reference to FIG. 20.

For convenience, the description which is given with reference to FIG. 12 will be omitted to avoid redundancy.

The image signal processor 150 may generate third luminance data LD3 based on the first to fourth luminance values LV1 to LV4 respectively corresponding to the first to fourth pixel units. The image signal processor 150 may generate image data by rearranging the luminance values LV1 to LV4 based on position information.

The image signal processor 150 may extract the luminance correction parameters LCP1 to LCP3 associated with the hybrid shutter data based on the rolling shutter data.

The image signal processor 150 may generate the first luminance correction parameter LCP1 associated with the second luminance value LV2 based on the first luminance value LV1. The image signal processor 150 may generate the second luminance correction parameter LCP2 associated with the second luminance value LV2 based on the third luminance value LV3. The image signal processor 150 may generate the third luminance correction parameter LCP3 associated with the second luminance value LV2 based on the fourth luminance value LV4.

The image signal processor 150 may correct the second luminance value LV2 based on the first luminance correction parameter LCP1, the third luminance correction parameter LCP3, and the fourth luminance correction parameter LCP4.

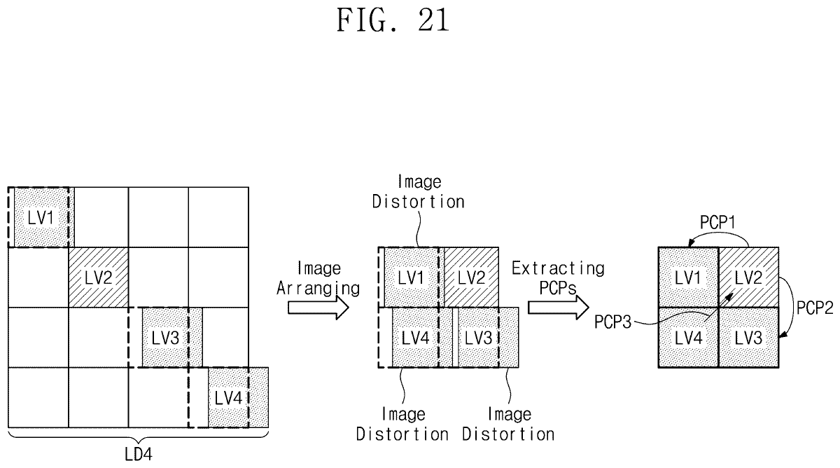

FIG. 21 is a diagram describing a method in which the image signal processor 150 of FIG. 1 operates based on the second mode signal, according to some embodiments. A method in which an image signal processor corrects rolling shutter data based on hybrid shutter data in relation with the first to fourth luminance values LV1 to LV4 described with reference to FIG. 19 will be described with reference to FIG. 21.

For convenience, the description which is given with reference to FIG. 14 will be omitted to avoid redundancy.

The image signal processor 150 may generate fourth luminance data LD4 based on the first to fourth luminance values LV1 to LV4. Also, the image signal processor 150 may generate pixel data by rearranging luminance values based on the fourth luminance data LD4 and position information.

In this case, in the fourth luminance data LD4 and the pixel data, there may be an error (i.e., displacement) of positions where the first luminance value LV1, the third luminance value LV3, and the fourth luminance value LV4 corresponding to the rolling pixel units are disposed. Referring to FIG. 21, an original position of the first luminance value LV1 is marked by a dotted line, and a position of the first luminance value LV1 displaced due to the error is marked by a bold solid line.

The position displacement may correspond to image distortion and may occur because an image sensor sequentially exposes pixel units located at the same column to the light depending on the rolling shutter manner.

The image signal processor 150 may extract the position correction parameters PCP1 to PCP3 associated with the rolling shutter data based on the hybrid shutter data.

The image signal processor 150 may generate the first position correction parameter PCP1 associated with the first luminance value LV1 (i.e., information about a position where the first luminance value LV1 is disposed), based on the second luminance value LV2 (i.e., based on information about a position where the second luminance value LV2 is disposed). The image signal processor 150 may generate the second position correction parameter PCP2 associated with the third luminance value LV3 based on the second luminance value LV2. The image signal processor 150 may generate the third position correction parameter PCP3 associated with the fourth luminance value LV4 based on the second luminance value LV2.

The image signal processor 150 may change a position where the first luminance value LV1 is disposed, based on the first position correction parameter PCP1. The image signal processor 150 may change a position where the third luminance value LV3 is disposed, based on the second position correction parameter PCP2. Also, the image signal processor 150 may correct a position where the fourth luminance value LV4 is disposed, based on the third position correction parameter PCP3.

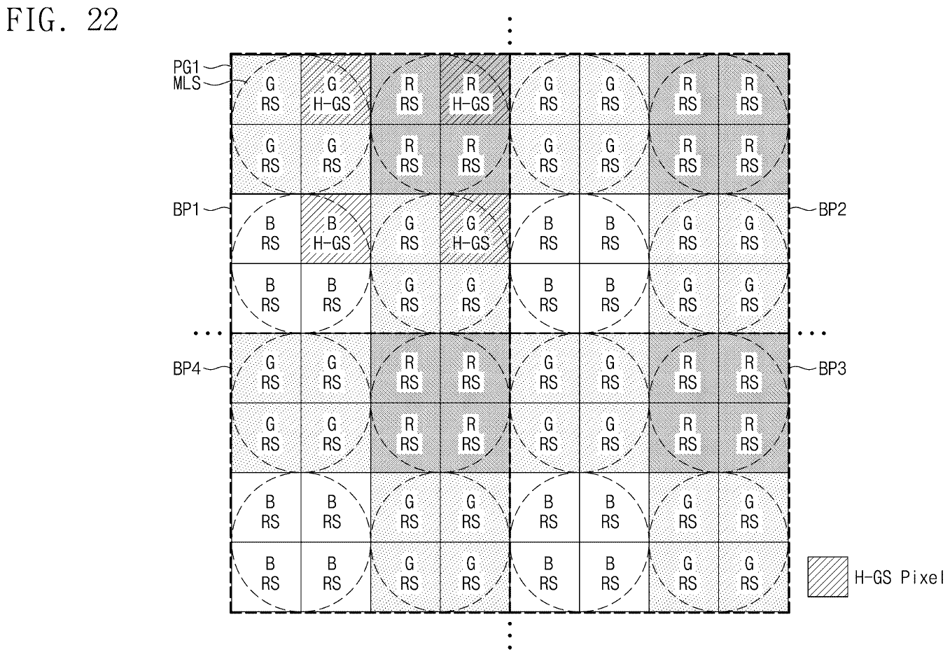

FIG. 22 is a diagram illustrating a pixel array according to some embodiments. Referring to FIG. 22, a pixel array includes four Bayer patterns BP1 to BP4 arranged in a matrix with two rows and two columns. The first Bayer pattern BP1 may be correspond to the first Bayer pattern BP1 of FIG. 17.

The first Bayer pattern BP1 of the pixel array, which is disposed at the first row and first column, may include a first pixel group PG1 and may include four pixel groups arranged in a matrix with two rows and two columns. Each pixel group may include four pixel units arranged in a matrix with two rows and two columns.

In some embodiments, three pixel units among the four pixel units may be the rolling pixel units RS, and the remaining pixel unit may be the hybrid pixel unit H-GS.

For example, the first pixel group PG1 may include first to fourth pixel units G₁ to G₄. In this case, the first pixel unit G1, the third pixel unit G₃, and the fourth pixel unit G₄ may be the rolling pixel units RS, and the second pixel unit G₂ may be the hybrid pixel unit H-GS.

A second Bayer pattern BP2 of the pixel array, which is disposed at the first row and second column, may include four pixel groups arranged in a matrix with two rows and two columns. Each pixel group may include four pixel units arranged in a matrix with two rows and two columns. In this case, all the pixel units included in the second Bayer pattern BP2 may be the rolling pixel units RS.

Each of the third Bayer pattern BP3 and the fourth Bayer pattern BP4 of the pixel array, which are disposed at the second row, may include only the rolling pixel units RS like the second Bayer pattern BP2.

The first to fourth Bayer patterns BP1 to BP4 may be repeated in the up, down, left, and right directions to constitute the pixel array.

However, the present disclosure is not limited thereto. For example, as in the above description given with reference to FIG. 7, the pixel groups in the first Bayer pattern BP1 may include two rolling pixel units PS and two hybrid pixel units H-GS.

Referring to FIGS. 7, 17, and 22, the proportion of the hybrid pixel unit H-GS among pixel units included in the pixel array may vary depending on embodiments. In the case of the pixel array of FIG. 7, the proportion of the hybrid pixel unit H-GS may be 50%. In the case of the pixel array of FIG. 17, the proportion of the hybrid pixel unit H-GS may be 25%. In the case of the pixel array of FIG. 22, the proportion of the hybrid pixel unit H-GS may be 6.25%.

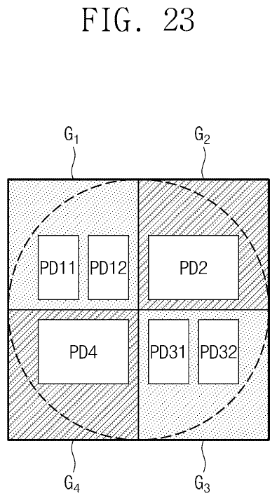

FIG. 23 is a diagram of the first pixel group PG1 of FIG. 7, according to some embodiments. Referring to FIG. 23, photodiodes respectively included in the first to fourth pixel units G₁ to G₄ of the first pixel group are illustrated.

The first pixel unit G₁ and the third pixel unit G₃ may be rolling pixel units. The second pixel unit G₂ and the fourth pixel unit G₄ may be hybrid pixel units.

In some embodiments, at least some of the rolling pixel units of the pixel array may be pixel units for auto-focusing.

In some embodiments, at least some of the rolling pixel units of the pixel array may be implemented with a 2-PD PDAF (Phase Detection Auto Focus) pixel unit. In this case, the corresponding rolling pixel unit may include two photodiodes. The 2-PD PDAF pixel unit may sense two phase information (e.g., right phase information and left phase information) through the two photodiodes.

For example, the first pixel unit G₁ may include two photodiodes PD11 and PD12. The third pixel unit G₃ may include two photodiodes PD31 and PD32. The second pixel unit G₂ being a hybrid pixel unit may include one photodiode PD2, and the fourth pixel unit G₄ may include one photodiode PD4.

In some embodiments, at least some of the rolling pixel units of the pixel array may be implemented with a 4-PD PDAF pixel unit. In this case, the corresponding rolling pixel unit may include four photodiodes.

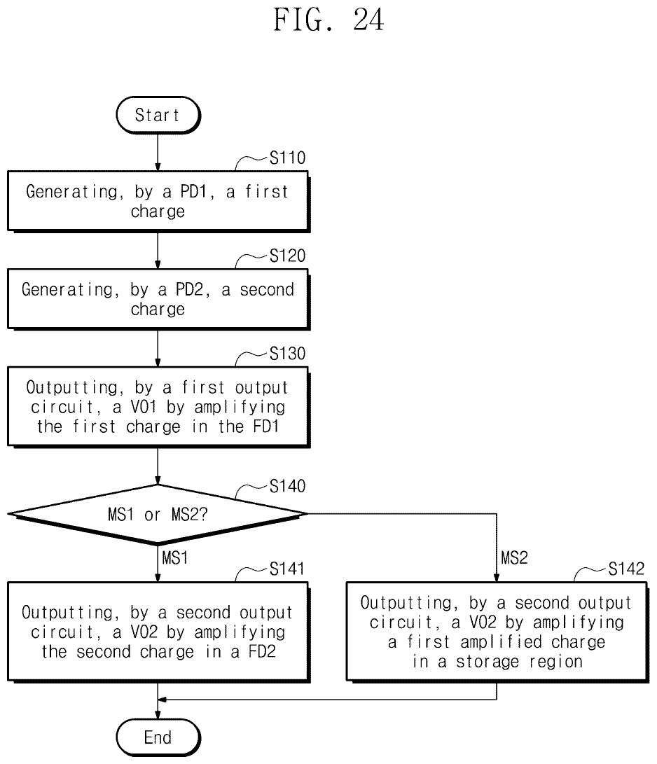

FIG. 24 is a flowchart describing a method in which the image sensor 100 of FIG. 1 operates, according to some embodiments.

The image sensor may include a first photodiode, a second photodiode, a first output circuit, and a second output circuit, which may respectively correspond to the first photodiode PD1, the second photodiode PD2, the first output circuit, and the second output circuit of FIG. 8.

In this case, the first photodiode PD1 and the second photodiode PD2 may be disposed under the same micro lens.

In some embodiments, the first photodiode PD1 and the second photodiode PD2 may be disposed under one color filter or may be respectively disposed under two color filters having the same color.

In operation S110, the first photodiode PD1 of the image sensor may generate a first charge.

In operation S120, the second photodiode PD2 of the image sensor may generate a second charge.

In operation S130, the first output circuit of the image sensor may transfer the first charge to the first floating diffusion region FD1 and may amplify the first charge to be output as the first output voltage VO1.

In operation S140, the image sensor may determine whether a received mode signal is the first mode signal MS1 or the second mode signal MS2.

In operation S141, in response to receiving the first mode signal MS1, the second output circuit of the image sensor may transfer a second charge to the second floating diffusion region FD2 and may amplify the second charge transferred to the second floating diffusion region FD2 to be output as the second output voltage VO2.

In operation S142, in response to receiving the second mode signal MS2, the second output circuit of the image sensor may amplify the second charge such that a first amplified charge is stored in a storage region and may amplify the first amplified charge stored in the storage region such that the second output voltage VO2 is output.

In some embodiments, the second output circuit may include the storage region.

In some embodiments, the storage region may include at least one capacitor. For example, the storage region may include a first capacitor and a second capacitor. The second output circuit may a charge corresponding to the reset voltage in the first capacitor and may store a charge corresponding to the pixel voltage in the second capacitor.

In some embodiments, the image sensor may further include an ADC circuit (e.g., the ADC circuit 130 of FIG. 1) and an image signal processor (e.g., the image signal processor 150 of FIG. 1). The ADC circuit of the image sensor may generate a first digital signal and a second digital signal respectively corresponding to the first output voltage VO1 and the second output voltage VO2. The image signal processor of the image sensor may generate a first luminance value and a second luminance value respectively corresponding to the first digital signal and the second digital signal. In addition, when a first mode signal is received, the image sensor may correct the second luminance value based on the first luminance value. Alternatively, when a second mode signal is received, the image sensor may correct the first luminance value based on the second luminance value.

A correction method is the same as that described in detail with reference to the above drawings.

For convenience of description, operations in which the photodiodes PD1 and PD2 generate a charge are illustrated as being sequential, but the present disclosure is not limited thereto. The order of the operations in which the photodiodes PD1 and PD2 generate a charge may be reversed, or the operations may be simultaneously performed.

Likewise, operations in which the first output circuit and the second output circuit output the output voltages VO1 and VO2 are illustrated as being sequential, but the present disclosure is not limited thereto. The order of the operations in which the first output circuit and the second output circuit output the output voltages VO1 and VO2 may be reversed, or the operations may be simultaneously performed.

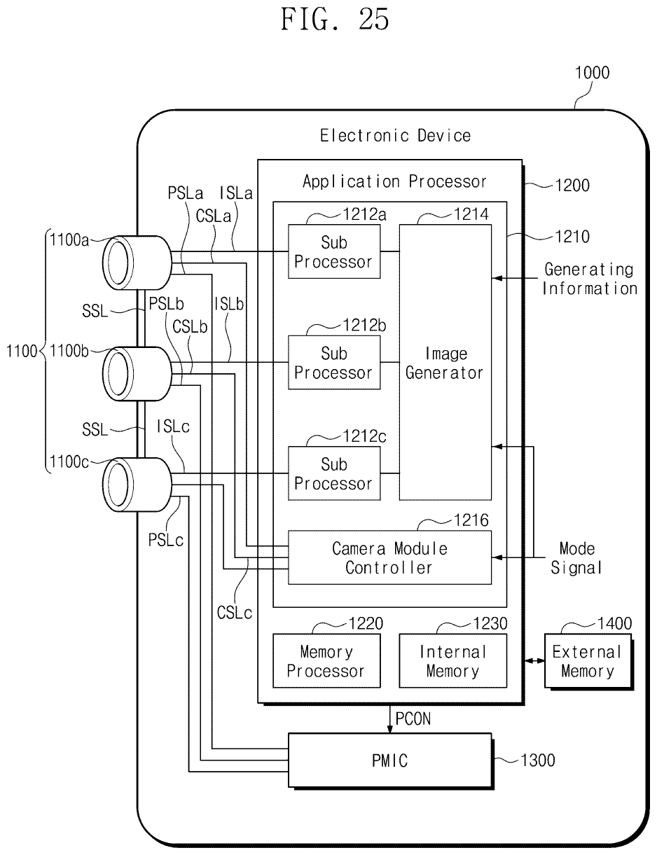

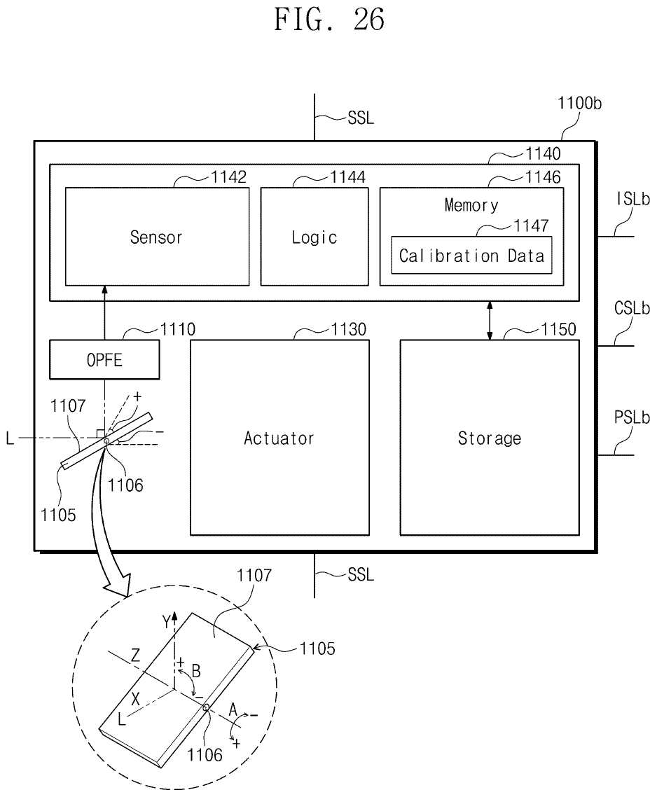

FIG. 25 is a block diagram of an electronic device including a multi-camera module according to some embodiments. FIG. 26 is a block diagram illustrating a camera module of FIG. 25 in detail.

Referring to FIG. 25, an electronic device 1000 may include a camera module group 1100, an application processor 1200, a power management integrated circuit (PMIC) 1300, and an external memory 1400.

The camera module group 1100 may include a plurality of camera modules 1100a, 1100b, and 1100c. An electronic device including three camera modules 1100a, 1100b, and 1100c is illustrated in FIG. 25, but the present disclosure is not limited thereto. In some embodiments, the camera module group 1100 may be modified to include only two camera modules. Also, in some embodiments, the camera module group 1100 may be modified to include “n” camera modules (n being a natural number of 4 or more).

Below, a detailed configuration of the camera module 1100b will be more fully described with reference to FIG. 26, but the following description may be equally applied to the remaining camera modules 1100a and 1100c.

Referring to FIG. 26, the camera module 1100b may include a prism 1105, an optical path folding element (OPFE) 1110, an actuator 1130, an image sensing device 1140, and storage 1150.

The prism 1105 may include a reflecting plane 1107 of a light reflecting material and may change a path of a light “L” incident from the outside.

In some embodiments, the prism 1105 may change a path of the light “L” incident in a first direction (X) to a second direction (Y) perpendicular to the first direction (X). The prism 1105 may change the path of the light “L” incident in the first direction (X) to the second direction (Y) perpendicular to the first (X-axis) direction by rotating the reflecting plane 1107 of the light reflecting material in direction “A” about a central axis 1106 or rotating the central axis 1106 in direction “B.” In this case, the OPFE 1110 may move in a third direction (Z) perpendicular to the first direction (X) and the second direction (Y).

In some embodiments, as illustrated in FIG. 26, a maximum rotation angle of the prism 1105 in direction “A” may be equal to or smaller than 15 degrees in a positive A direction and may be greater than 15 degrees in a negative A direction, but the present disclosure is not limited thereto.

In some embodiments, the prism 1105 may move within approximately 20 degrees in a positive or negative B direction, between 10 degrees and 20 degrees, or between 15 degrees and 20 degrees. In some embodiments, the prism 1105 may move at the same angle in the positive or negative B direction or may move at a similar angle within approximately 1 degree.

In some embodiments, the prism 1105 may move the reflecting plane 1107 of the light reflecting material in the third direction (e.g., Z direction) parallel to a direction in which the central axis 1106 extends.

The OPFE 1110 may include optical lenses composed of “m” groups (m being a natural number), for example. In some embodiments, “m” lens may move in the second direction (Y) to change an optical zoom ratio of the camera module 1100b. For example, when a default optical zoom ratio of the camera module 1100b is “Z”, the optical zoom ratio of the camera module 1100b may be changed to an optical zoom ratio of 3Z, 5Z, or more by moving “m” optical lens included in the OPFE 1110.

The actuator 1130 may move the OPFE 1110 or an optical lens (hereinafter referred to as an “optical lens”) to a specific location. For example, the actuator 1130 may adjust a location of an optical lens such that an image sensor 1142 is placed at a focal length of the optical lens for accurate sensing.

The image sensing device 1140 may include the image sensor 1142, control logic 1144, and a memory 1146. The image sensor 1142 may sense an image of a sensing target by using the light “L” provided through an optical lens. The control logic 1144 may control overall operations of the camera module 1100b. For example, the control logic 1144 may control an operation of the camera module 1100b based on a control signal provided through a control signal line CSLb.

The memory 1146 may store information for an operation of the camera module 1100b, such as calibration data 1147. The calibration data 1147 may include information for the camera module 1100b to generate image data by using the light “L” provided from the outside. The calibration data 1147 may include, for example, information about the degree of rotation described above, information about a focal length, information about an optical axis, etc. In the case where the camera module 1100b is implemented in the form of a multi-state camera in which a focal length varies depending on a location of an optical lens, the calibration data 1147 may include a focal length value for each location (or state) of the optical lens and information about auto-focusing.

The storage 1150 may store image data sensed through the image sensor 1142. The storage 1150 may be disposed outside the image sensing device 1140 and may be implemented in a shape where the storage 1150 and a sensor chip constituting the image sensing device 1140 are stacked. In some embodiments, the storage 1150 may be implemented with an electrically erasable programmable read only memory (EEPROM), but the present disclosure is not limited thereto.

Referring together to FIGS. 25 and 26, in some embodiments, each of the plurality of camera modules 1100a, 1100b, and 1100c may include the actuator 1130. As such, the same calibration data 1147 or different calibration data 1147 may be included in the plurality of camera modules 1100a, 1100b, and 1100c depending on operations of the actuators 1130 therein.

In some embodiments, one camera module (e.g., 1100b) among the plurality of camera modules 1100a, 1100b, and 1100c may be a folded lens shape of camera module in which the prism 1105 and the OPFE 1110 described above are included, and the remaining camera modules (e.g., 1100a and 1100c) may be a vertical shape of camera module in which the prism 1105 and the OPFE 1110 described above are not included; however, the present disclosure is not limited thereto.

In some embodiments, one camera module (e.g., 1100c) among the plurality of camera modules 1100a, 1100b, and 1100c may be, for example, a vertical shape of depth camera extracting depth information by using an infrared ray (IR). In this case, the application processor 1200 may merge image data provided from the depth camera and image data provided from any other camera module (e.g., 1100a or 1100b) and may generate a three-dimensional (3D) depth image.

In some embodiments, at least two camera modules (e.g., 1100a and 1100b) among the plurality of camera modules 1100a, 1100b, and 1100c may have different fields of view. In this case, the at least two camera modules (e.g., 1100a and 1100b) among the plurality of camera modules 1100a, 1100b, and 1100c may include different optical lenses, but the present disclosure is not limited thereto.

Also, in some embodiments, fields of view of the plurality of camera modules 1100a, 1100b, and 1100c may be different. In this case, the plurality of camera modules 1100a, 1100b, and 1100c may include different optical lenses, but is not limited thereto.

In some embodiments, the plurality of camera modules 1100a, 1100b, and 1100c may be disposed to be physically separated from each other. That is, the plurality of camera modules 1100a, 1100b, and 1100c may not use a sensing area of one image sensor 1142, but the plurality of camera modules 1100a, 1100b, and 1100c may include independent image sensors 1142 therein, respectively.

Returning to FIG. 25, the application processor 1200 may include an image processing device 1210, a memory controller 1220, and an internal memory 1230. The application processor 1200 may be implemented to be separated from the plurality of camera modules 1100a, 1100b, and 1100c. For example, the application processor 1200 and the plurality of camera modules 1100a, 1100b, and 1100c may be implemented with separate semiconductor chips.

The image processing device 1210 may include a plurality of sub image processors 1212a, 1212b, and 1212c, an image generator 1214, and a camera module controller 1216.

The image processing device 1210 may include the plurality of sub image processors 1212a, 1212b, and 1212c, the number of which corresponds to the number of the plurality of camera modules 1100a, 1100b, and 1100c.

Image data respectively generated from the camera modules 1100a, 1100b, and 1100c may be respectively provided to the corresponding sub image processors 1212a, 1212b, and 1212c through separate image signal lines ISLa, ISLb, and ISLc. For example, the image data generated from the camera module 1100a may be provided to the sub image processor 1212a through the image signal line ISLa, the image data generated from the camera module 1100b may be provided to the sub image processor 1212b through the image signal line ISLb, and the image data generated from the camera module 1100c may be provided to the sub image processor 1212c through the image signal line ISLc. This image data transmission may be performed, for example, by using a camera serial interface (CSI) based on the MIPI (Mobile Industry Processor Interface), but the present disclosure is not limited thereto.

In some embodiments, one sub image processor may be disposed to correspond to a plurality of camera modules. For example, the sub image processor 1212a and the sub image processor 1212c may be integrally implemented, not separated from each other as illustrated in FIG. 25. In this case, one of the pieces of image data respectively provided from the camera module 1100a and the camera module 1100c may be selected through a selection element (e.g., a multiplexer), and the selected image data may be provided to the integrated sub image processor.

The image data respectively provided to the sub image processors 1212a, 1212b, and 1212c may be provided to the image generator 1214. The image generator 1214 may generate an output image by using the image data respectively provided from the sub image processors 1212a, 1212b, and 1212c, depending on image generating information (Generating Information) or a mode signal.

In some embodiments, the image generator 1214 may generate the output image by merging at least a portion of the image data respectively generated from the camera modules 1100a, 1100b, and 1100c having different fields of view, depending on the Generating Information or the mode signal. The image generator 1214 may generate the output image by selecting one of the image data respectively generated from the camera modules 1100a, 1100b, and 1100c having different fields of view, depending on the Generating Information or the mode signal.

In some embodiments, the Generating Information may include a zoom signal or a zoom factor. In some embodiments, the mode signal may be, for example, a signal based on a mode selected by a user.

In the case where the Generating Information is the zoom signal (or zoom factor) and the camera modules 1100a, 1100b, and 1100c have different visual fields of view, the image generator 1214 may perform different operations depending on a kind of the zoom signal. For example, in the case where the zoom signal is a first signal, the image generator 1214 may merge the image data output from the camera module 1100a and the image data output from the camera module 1100c and may generate the output image by using the merged image signal and the image data output from the camera module 1100b is not used in the merging operation. In the case where the zoom signal is a second signal different from the first signal, without the image data merging operation, the image generator 1214 may select one of the image data respectively output from the camera modules 1100a, 1100b, and 1100c and may output the selected image data as the output image. However, the present disclosure is not limited thereto, and a way to process image data may be modified without limitation.

In some embodiments, the image generator 1214 may generate merged image data having an increased dynamic range by receiving a plurality of image data of different exposure times from at least one of the plurality of sub image processors 1212a, 1212b, and 1212c and performing high dynamic range (HDR) processing on the plurality of image data.

The camera module controller 1216 may provide control signals to the camera modules 1100a, 1100b, and 1100c, respectively. The control signals generated from the camera module controller 1216 may be respectively provided to the corresponding camera modules 1100a, 1100b, and 1100c through control signal lines CSLa, CSLb, and CSLc separated from each other.

One of the plurality of camera modules 1100a, 1100b, and 1100c may be designated as a master camera (e.g., 1100b) depending on the Generating Information including the zoom signal or the mode signal, and the remaining camera modules (e.g., 1100a and 1100c) may be designated as a slave camera. The above designation information may be included in the control signals, and the control signals including the designation information may be respectively provided to the corresponding camera modules 1100a, 1100b, and 1100c through the control signal lines CSLa, CSLb, and CSLc.

Camera modules operating as a master and a slave may be changed depending on the zoom factor or an operating mode signal. For example, in the case where the field of view of the camera module 1100a is wider than the field of view of the camera module 1100b and the zoom factor indicates a low zoom ratio, the camera module 1100b may operate as a master, and the camera module 1100a may operate as a slave. In contrast, in the case where the zoom factor indicates a high zoom ratio, the camera module 1100a may operate as a master, and the camera module 1100b may operate as a slave.

In some embodiments, the control signal provided from the camera module controller 1216 to each of the camera modules 1100a, 1100b, and 1100c may include a sync enable signal. For example, in the case where the camera module 1100b is used as a master camera and the camera modules 1100a and 1100c are used as slave cameras, the camera module controller 1216 may transmit the sync enable signal to the camera module 1100b. The camera module 1100b that is provided with sync enable signal may generate a sync signal based on the provided sync enable signal and may provide the generated sync signal to the camera modules 1100a and 1100c through a sync signal line SSL. The camera module 1100b and the camera modules 1100a and 1100c may be synchronized with the sync signal to transmit image data to the application processor 1200.

In some embodiments, the control signal provided from the camera module controller 1216 to each of the camera modules 1100a, 1100b, and 1100c may include mode information according to the mode signal. Based on the mode information, the plurality of camera modules 1100a, 1100b, and 1100c may operate in a first operating mode and a second operating mode with regard to a sensing speed.

In the first operating mode, the plurality of camera modules 1100a, 1100b, and 1100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 1200. In this case, the second speed may be 30 times or less the first speed.

The application processor 1200 may store the received image signals, that is, the encoded image signals in the memory 1230 provided therein or the external memory 1400 placed outside the application processor 1200. Afterwards, the application processor 1200 may read and decode the encoded image signals from the memory 1230 or the external memory 1400 and may display image data generated based on the decoded image signals. For example, the corresponding one among sub image processors 1212a, 1212b, and 1212c of the image processing device 1210 may perform decoding and may also perform image processing on the decoded image signal.

In the second operating mode, the plurality of camera modules 1100a, 1100b, and 1100c may generate image signals at a third speed (e.g., may generate image signals of a third frame rate lower than the first frame rate) and transmit the image signals to the application processor 1200. The image signals provided to the application processor 1200 may be signals that are not encoded. The application processor 1200 may perform image processing on the received image signals or may store the image signals in the memory 1230 or the external memory 1400.

The PMIC 1300 may supply power, for example, power supply voltages, to the plurality of camera modules 1100a, 1100b, and 1100c, respectively. For example, under control of the application processor 1200, the PMIC 1300 may supply a first power to the camera module 1100a through a power signal line PSLa, may supply a second power to the camera module 1100b through a power signal line PSLb, and may supply a third power to the camera module 1100c through a power signal line PSLc.

In response to a power control signal PCON from the application processor 1200, the PMIC 1300 may generate a power corresponding to each of the plurality of camera modules 1100a, 1100b, and 1100c and may adjust a level of the power. The power control signal PCON may include a power adjustment signal for each operating mode of the plurality of camera modules 1100a, 1100b, and 1100c. For example, the operating mode may include a low-power mode. In this case, the power control signal PCON may include information about a camera module operating in the low-power mode and a set power level. Levels of the powers respectively provided to the plurality of camera modules 1100a, 1100b, and 1100c may be identical to each other or may be different from each other. In some embodiments, a level of a power may be dynamically changed.

According to some embodiments, an image sensor and an operation method of the image sensor are provided.

In some embodiments, as a pixel capable of operating in a hybrid shutter manner (i.e., operating in both a global shutter manner and a rolling shutter manner) and a pixel capable of operating in the rolling shutter manner are together disposed in a pixel array, an image sensor capable of improving the quality of image of the pixel operating in the hybrid shutter manner or reducing image distortion of the pixel operating in the rolling shutter manner is provided.

While the present disclosure has been described with reference to embodiments thereof, it will be apparent to those of ordinary skill in the art that various changes and modifications may be made thereto without departing from the scope of the present disclosure as set forth in the following claims.

What is claimed is:

1. An image sensor, comprising:
a first photodiode disposed under a first micro lens and configured to generate a first charge;
a second photodiode disposed under the first micro lens and configured to generate a second charge;
a first output circuit configured to:
transfer the first charge to a first floating diffusion region;
amplify the first charge; and
output the amplified first charge as a first output voltage; and
a second output circuit configured to:
based on a first mode signal:
transfer a second charge to a second floating diffusion region;
amplify the second charge; and
output the amplified second charge as a second output voltage; and
based on a second mode signal:
amplify the second charge to generate a first amplified charge;
store the first amplified charge in a storage region;
amplify the first amplified charge stored in the storage region; and
output the amplified first amplified charge as the second output voltage.

2. The image sensor of claim 1, wherein the second output circuit includes the storage region.

3. The image sensor of claim 2, wherein the storage region includes at least one capacitor.

4. The image sensor of claim 1, wherein the first photodiode and the second photodiode are disposed under a first color filter.

5. The image sensor of claim 1, wherein:
the first photodiode is disposed under a first color filter;
the second photodiode is disposed under a second color filter; and
a color of the second color filter is identical to a color of the first color filter.

6. The image sensor of claim 1, further comprising:
an analog-to-digital converter (ADC) circuit configured to:
convert the first output voltage into a first digital signal; and
convert the second output voltage into a second digital signal; and
an image signal processor configured to:
generate a first luminance value corresponding to the first digital signal;
generate a second luminance value corresponding to the second digital signal; and
correct the second luminance value based on the first luminance value in response to the first mode signal.

7. The image sensor of claim 6, wherein, based on the first mode signal, the image signal processor is further configured to:
extract offset values of the second luminance value as a luminance correction parameter, based on the first luminance value; and
correct the second luminance value based on the luminance correction parameter.

8. The image sensor of claim 1, further comprising:
an analog-to-digital converter (ADC) circuit configured to:
convert the first output voltage into a first digital signal; and
convert the second output voltage into a second digital signal; and
an image signal processor configured to:
generate a first luminance value corresponding to the first digital signal;
generate a second luminance value corresponding to the second digital signal; and
correct a first position in image data where the first luminance value is disposed, based on a second position in the image data where the second luminance value is disposed, based on the second mode signal, wherein the first position corresponds to a position of the first photodiode that generated the first charge and the second position corresponds to a position of the second photodiode that generated the second charge.

9. The image sensor of claim 8, wherein, based on the second mode signal, the image signal processor is further configured to:
extract a position correction parameter associated with the second position in the image data where the second luminance value is disposed, based on the first position in the image data where the first luminance value is disposed; and
correct the first position in the image data where the first luminance value is disposed, based on the position correction parameter.

10. The image sensor of claim 8, wherein:
after the second output circuit outputs the second output voltage based on the second mode signal, the second photodiode further generates an additional charge;
the second output circuit is further configured to:
amplify the additional charge;
store the amplified additional charge in the storage region;
amplify the additional amplified charge stored in the storage region; and
output the amplified additional amplified charge as an additional output voltage;
the ADC circuit is further configured to convert the additional output voltage into an additional digital signal; and
the image signal processor is further configured to:
generate an additional luminance value corresponding to the additional digital signal; and
correct the corrected position of the first luminance value based on a position in the image data where the additional luminance value is disposed.

11. The image sensor of claim 1, further comprising:
a third photodiode disposed under the first micro lens and configured to generate a third charge; and
a fourth photodiode disposed under the first micro lens and configured to generate a fourth charge,
wherein:
the first output circuit is further configured to:
transfer the third charge to the first floating diffusion region;
amplify the third charge; and
output the amplified third charge as a third output voltage; and
the second output circuit is further configured to:
based on the first mode signal:
transfer the fourth charge to the second floating diffusion region; and
amplify the fourth charge; and
output the amplified fourth charge as a fourth output voltage; and
based on the second mode signal:
amplify the fourth charge to generate a second amplified charge;
store the second amplified charge in the storage region;
amplify the second amplified charge stored in the storage region; and
output the amplified second amplified charge as the fourth output voltage.

12. The image sensor of claim 11, wherein:
the first photodiode and the third photodiode receive a light during time periods which are at least partially different from each other; and
the second photodiode and the fourth photodiode receive a light during substantially the same time period, based on the second mode signal.

13. The image sensor of claim 11, further comprising:
an analog-to-digital converter (ADC) circuit configured to:
convert the first output voltage into a first digital signal;
convert the second output voltage into a second digital signal;
convert the third output voltage into a third digital signal; and
convert the fourth output voltage into a fourth digital signal; and
an image signal processor configured to:
generate a first luminance value corresponding to the first digital signal;
generate a second luminance value corresponding to the second digital signal;
generate a third luminance value corresponding to the third digital signal;
generate a fourth luminance value corresponding to the fourth digital signal; and
correct the second luminance value and the fourth luminance value based on the first luminance value and the third luminance value in response to the first mode signal.

14. The image sensor of claim 11, further comprising:
an analog-to-digital converter (ADC) circuit configured to:
convert the first output voltage into a first digital signal;
convert the second output voltage into a second digital signal;
convert the third output voltage into a third digital signal; and
convert the fourth output voltage into a fourth digital signal; and
an image signal processor configured to:
generate a first luminance value corresponding to the first digital signal;
generate a second luminance value corresponding to the second digital signal;
generate a third luminance value corresponding to the third digital signal;
generate a fourth luminance value corresponding to the fourth digital signal; and
correct positions in image data where the first luminance value and the third luminance value are disposed, based on positions in the image data where the second luminance value and the fourth luminance value in response to the second mode signal, wherein the positions correspond to positions of the photodiodes that generated the charge.

15. The image sensor of claim 1, further comprising:
a third photodiode disposed under the first micro lens and configured to generate a third charge; and
a fourth photodiode disposed under the first micro lens and configured to generate a fourth charge,
wherein:
the first output circuit is further configured to:
transfer the third charge to the first floating diffusion region;
amplify the third charge;
output the amplified third charge as a third output voltage;
transfer the fourth charge to the first floating diffusion region;
amplify the fourth charge; and
output the amplified fourth charge as a fourth output voltage.

16. The image sensor of claim 15, further comprising:
an analog-to-digital converter (ADC) circuit configured to:
convert the first output voltage into a first digital signal;
convert the second output voltage into a second digital signal;
convert the third output voltage into a third digital signal; and
convert the fourth output voltage into a fourth digital signal; and
an image signal processor configured to:
generate a first luminance value corresponding to the first digital signal;
generate a second luminance value corresponding to the second digital signal;
generate a third luminance value corresponding to the third digital signal;
generate a fourth luminance value corresponding to the fourth digital signal; and
correct the second luminance value based on the first luminance value, the third luminance value, and the fourth luminance value in response to the first mode signal.

17. The image sensor of claim 15, further comprising:
an analog-to-digital converter (ADC) circuit configured to:
convert the first output voltage into a first digital signal;
convert the second output voltage into a second digital signal;
convert the third output voltage into a third digital signal; and
convert the fourth output voltage into a fourth digital signal; and
an image signal processor configured to:
generate a first luminance value corresponding to the first digital signal;
generate a second luminance value corresponding to the second digital signal;
generate a third luminance value corresponding to the third digital signal;
generate a fourth luminance value corresponding to the fourth digital signal; and
correct positions in image data where the first luminance value, the third luminance value, and the fourth luminance value are disposed, based on a position in the image data where the second luminance value is disposed, in response to the second mode signal, wherein the positions correspond to positions of the photodiodes that generated the charge.

18. The image sensor of claim 1, wherein:
the image sensor includes a first layer, a second layer, and a third layer overlapping in a vertical direction;
the first photodiode and the second photodiode are disposed in the first layer;
a first pre-charge transistor included in the first output circuit is disposed in the third layer and remaining components of the first output circuit are disposed in the first layer; and
the storage region of the second output circuit and a second pre-charge transistor of the second output circuit are disposed in the second layer.

19. An image sensor, comprising:
a first photodiode;
a second photodiode;
a first output circuit connected to the first photodiode and configured to operate in a rolling shutter manner; and
a second output circuit connected to the second photodiode and configured to:
operate in the rolling shutter manner based on a first mode signal; and
operate in a global shutter manner based on a second mode signal, wherein the first photodiode and the second photodiode are disposed under a first micro lens.

20. An operation method of an image sensor which includes a first photodiode, a second photodiode, a first output circuit, and a second output circuit, the first photodiode and the second photodiode being disposed under a first micro lens, the method comprising:
generating, by the first photodiode, a first charge;
generating, by the second photodiode, a second charge;
using the first output circuit to:
transfer the first charge to a first floating diffusion region;
amplify the first charge; and
output the amplified first charge as a first output voltage;
in response to receiving a first mode signal, using the second output circuit to:
transfer a second charge to a second floating diffusion region;
amplify the second charge; and
output the amplified second charge as a second output voltage; and
in response to receiving a second mode signal, using the second output circuit to:
amplify the second charge;
store the amplified second charge as a first amplified charge in a storage region;
amplify the first amplified charge stored in the storage region; and
output the amplified first amplified charge as the second output voltage.
